(19) United States
(12) Patent Application Publication
(10) Pub. No.: US 2015/0269512 A1
(43) Pub. Date: Sep. 24, 2015

(54) Productivity Assessment and Rewards Systems and Processes Therefor

(71) Applicant: Daniel DANIEL WARTEL, Southfild, MI (US)

(72) Inventor: Daniel Wartel, Southfield, MI (US)

(21) Appl. No.: 14/435,135

(22) PCT Filed: Oct. 10, 2013
(86) PCT No.: PCT/US13/64408

§ 371 Date: Apr. 10, 2015

Related U.S. Application Data
(60) Provisional application No. 61/795,078, filed on Oct. 10, 2012.

(51) Int. Cl. G06Q 10/06

(52) U.S. Cl. CPC G06Q 10/06393

(57) ABSTRACT

Performance systems assess and track operational and functional performance for the purpose of rewarding those workers that provide the most value to an enterprise. Initially, management decides what is important in a particular job, a way to track performance by defining a plurality of performance criteria, an algorithm to quantify and compare performance of workers and a reward for top performance. Performance criteria are assigned weights by management. Performance criteria are mathematically processed with assigned weights for a preset period, such as by summing the products of measurement of criteria with their weights, to create a periodic single numerical assessment of overall performance of workers, such as for a pay period, for comparison with other workers performing a similar job. Performance of workers is compared to determine distribution of periodic rewards, such as cash bonuses, and, in the best mode, the value of such reward.

### CROSS REFERENCE

This application claims priority from provisional application Ser. No. 61/795,078 filed on 10 Oct. 2012 bearing the title PRODUCTIVITY ASSESSMENT REWARDS SYSTEM and all disclosures are incorporated by reference herein.

### TECHNICAL FIELD

This invention generally relates to the field of assessing a worker's real-time productivity, and more particularly, to systems and methods for instantaneously and periodically assessing and tracking operational and functional performance of workers for the purpose of rewarding those workers for attributes and behaviors that provide the most value to the organization which employs them.

### BACKGROUND OF THE DISCLOSURE

Whether they are businesses, nonprofits, or government agencies, every entity grapples with productivity, quality, and budgets. Generally, one of the biggest cost items for such entities is payroll and related costs. Nonetheless, most entities do not have a scientific way to analyze whether they are getting their money's worth from their payroll or not. There is good reason. Defining a measure of productivity for each job is difficult and inexact. Reliable methods to track employee productivity are largely nonexistent.

Other large cost are those arising directly and indirectly from quality—including costs incurred to improve quality and costs arising from breakdowns in quality. Several systems have been suggested to address related problems.

U.S. Patent Document No. 20030225610 (Doyle) discloses a method for motivating independent business owners in which the independent business owners are divided into at least two teams, each team having a plurality of persons who are independent business owners. A plurality of business activity categories which relate favorably to success of the independent business owner in his or her business field is identified. Thereafter, the effort expended by each person on each team in each category is inputted, preferably by computer over the Internet, at predetermined time intervals. A score is assigned to each person in each category during each time interval and these scores for each team are then tabulated over the preset time duration. The team achieving the highest win/loss record for each time interval is named the winning team and accorded appropriate recognition, prizes or the like.

U.S. Patent Document No. 20010032195 (Graichen; et al.) discloses a system for identifying productivity improvements in a business organization. The system of this disclosure includes a business operations database that contains a plurality of operational data obtained from a plurality of business organizations, a processor that analyzes the plurality of operational data to identify productivity improvements in the business organization, and an analysis logic that calculates an operational efficiency of the business organization. The method provides for efficiency and cost analysis of business operations. The method includes the steps of storing a plurality of operational data obtained from a plurality of business organizations. With the plurality of operational data, the method identifies productivity improvements in the business organization and calculates an operational efficiency of the business organization.

U.S. Pat. No. 8,015,197 (Zitaner, et al.) discloses a competitive rewards benchmarking system. The invention concerns a system and method for implementing and/or administering a competitive rewards database. Member data is received from at least one member computer via a data feed. The (raw) member data is automatically mapped and incorporated into the competitive rewards database. A data capture tool, preferably coupled to a data network, is operable to adjust the mapping of member data. A rewards workbench, preferably coupled to a data network, is generally operable to query the competitive rewards database.

None of these systems provides a mechanism to provide automated data input from multiple sources. None provides for frequent periodic incentives to workers tied directly to their contribution to the profitability. None provides a streamlined process for comparing productivity between workers having different job assignments or responsibilities. None provides a process for modifying and evolving performance criteria based upon learning's from prior measurements.

### SUMMARY OF THE DISCLOSURE

The productivity assessment rewards system disclosed herein provides various embodiments to fill these and additional needs of a business enterprise.

In various embodiments, the present disclosure provides a system that identifies those workers that enhance the profitability of their organization, whereby the organization shares the added profit with said workers who so perform in an exemplary manner during said pay period; a system that enables the workers to monitor their own performance relative to guidelines and tasks preset by management, said performance being compared with other workers within the organization having similar responsibilities.

Additionally, in various embodiments, the present disclosure provides a system enabling management to identify and reward those workers that meet or exceed expectations during a predetermined time interval without the need for management intervention; a system that enables management to raise and lower the amount of the rewards paid periodically based upon organization performance and cash flow.

Still additionally, in various embodiments, the present disclosure provides a system that enables management to raise the profitability level of an organization by advising each individual worker what is expected, thereby enhancing the performance level of the entire organization; enabling the organization to identify problem areas so that said problem areas can be upgraded with the necessary machines, computers, software, and training to enable the organization to outperform the competition.

Yet additionally, in various embodiments, the present disclosure provides a system that enables an enterprise to motivate its workforce, so that the management identifies and retains the key members of its workforce who become vested in the organization as the organization grows and prospers, the key members of its workforce sharing predetermined rewards as the organization grows and prospers; a tool that enables management to duplicate a business model in another venue, either in the same country or on the other side of the planet, and know that if certain factors can be duplicated, the business model can achieve similar results.

For a more complete disclosure of the productivity appraisal and rewards systems disclosed herein, reference is made to the following detailed description of the invention and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

Some configurations of the productivity assessment and rewards systems and related processes will now be described, by way of example only and without disclaimer of other configurations, with reference to the accompanying drawings, in which:

FIG. 1 is a graphic view a simplified system schematic of an exemplary enterprise environment for a productivity system.

FIG. 2 is a graphic depiction of the participants in an exemplary process at the exemplary enterprise of FIG. 1.

FIG. 3 is a schematic view of an exemplary productivity system for the enterprise environment of FIG. 1 including an exemplary enterprise data system and exemplary personnel, hardware and software components of the productivity system.

FIG. 4 is a schematic view of the productivity data system of the productivity system of FIG. 3 including a graphic depiction of a few additional data and hardware components of the productivity system.

FIG. 5 is a flow chart depicting steps in an exemplary productivity data process using the productivity system of FIGS. 3 and 4.

FIG. 6 is a flow chart depicting steps in an alternative exemplary productivity data process using the productivity system of FIGS. 3 and 4.

FIG. 7 is a flow chart depicting steps in an exemplary productivity data initiation process using the productivity system of FIGS. 3 and 4.

FIG. 8 is a flow chart depicting steps in an exemplary productivity data management process using the productivity system of FIGS. 3 and 4.

FIG. 9 is a flow chart depicting steps in an alternative exemplary productivity data management process using the productivity system of FIGS. 3 and 4.

FIGS. 10A, 10B and 10C are a flow chart depicting steps in an alternative exemplary productivity data process using the productivity system of FIGS. 3 and 4.

FIG. 11 depicts an EXCEL spreadsheet disclosing a Main Menu of an exemplary productivity data system.

FIG. 12 depicts an EXCEL spreadsheet disclosing a Set-Up Utilities Menu of the exemplary productivity data system of FIG. 11.

FIGS. 13A, 13B, and 13C depict EXCEL spreadsheets disclosing Bonus Criteria of the exemplary productivity data system of FIG. 11.

FIGS. 14A and 14D depict portions of an EXCEL spreadsheet disclosing Performance Criteria Template of the exemplary productivity data system of FIG. 11.

FIG. 15 depicts an EXCEL spreadsheet disclosing Employee List for Job Type of the exemplary productivity data system of FIG. 11.

FIG. 16A depicts an EXCEL portion of a spreadsheet disclosing Define Pay Periods of the exemplary productivity data system of FIG. 11.

FIG. 16B depicts an EXCEL portion of spreadsheet disclosing Pay Periods for Productivity Analysis of the exemplary productivity data system of FIG. 11 determined by the Define Pay Period chart of FIG. 16A.

FIG. 17 depicts an EXCEL spreadsheet disclosing Work Orders of the exemplary productivity data system of FIG. 11.

FIG. 18 depicts an EXCEL spreadsheet disclosing Customers of the exemplary productivity data system of FIG. 11.

FIG. 19 depicts an EXCEL spreadsheet disclosing Machines of the exemplary productivity data system of FIG. 11.

FIG. 20 depicts an EXCEL worksheet for inputting and viewing data relating to work orders.

FIG. 21 depicts an EXCEL worksheet containing a Performance Input and Quick Results Chart Machines of the exemplary productivity data system of FIG. 11.

FIGS. 22a and 22B depict an EXCEL worksheet containing Bonus Calculation Chart of the exemplary productivity data system of FIG. 11.

FIG. 23 through 28 depict various graphs and charts that may be derived from the data collected in the exemplary productivity data system of FIG. 11.

FIGS. 29 through 34 depict an exemplary Productive Labor & Overhead Rate Calculator the exemplary productivity data system of FIG. 11.

FIGS. 35A through 35N and 36A through 36D through depict various graphs and charts that may be derived from the data collected in the exemplary productivity data system of FIG. 11 and the Productive Labor & Overhead Rate Calculator of FIGS. 29 through 34.

### DETAILED DESCRIPTION OF THE DRAWINGS

The present invention provides a productivity assessment and rewards systems and related processes. The productivity system may include a plurality of subsystems and subprocesses. The many details, features, advantages disclosed herein will become apparent from the below description of exemplary systems and components shown in the attached drawings.

As used herein, the terms “organization” or “enterprise” are understood to mean any company, portion of a company, government, unit or agency of government, school, college or university, public or privately-held corporation, for-profit or non-profit, non-governmental organization, international organization, club, church, union, team, charity, partnership, and cooperative as well as subsets and supersets thereof as well as other groupings of people or enterprises having permanent, temporary, official, unofficial, formal and/or informal status but working together to produce an output or achieve an outcome. A hybrid organization is a body that operates in both the public sector and the private sector simultaneously, fulfilling public duties and developing commercial market activities. A “business enterprise” is a for-profit or non-profit enterprise providing a product or service to individuals or other enterprises.

As used herein, the word “worker” is understood to mean a full or part-time employee, a full or part-time independent contractor, someone hired full or part-time from a staffing agency, a job-specific hire, or any other individual who makes up a component part of a workforce of an enterprise. A “participant” is a worker or any other individual, entity or team participating in a process to produce an output.

As used herein, the term “product” is understood to mean any physical, intellectual, financial, virtual, or other valuable thing created or modified by the efforts of an enterprise. A “service” is any activity which is performed by a person or an enterprise for the benefit of a person or organization. A “result” is a change in any product, service, law, behavior, action, knowledge level, attitude, position, bias or the like caused by the activity of a person or an enterprise. The term “output” means any product, service or result, as defined above, from the efforts of an enterprise. An “output” is any product, service or result.

All terms are intended to be given their broadest reasonable constructions and their ordinary meanings as understood by those skilled in the art unless an explicit indication to the contrary in made herein. In particular, use of the singular articles such as “a” and “the,” should be read to recite one or more of the indicated elements unless a claim recites an explicit limitation to the contrary.

Referring now to the drawings generally, wherein like reference numerals are used for like components, exemplary systems and processes are shown. Although the drawings represent alternative configurations of productivity systems and processes, the configurations set forth herein are not intended to be exhaustive or to otherwise limit the invention to the precise components disclosed in the following detailed description and the attached drawings. For example, steps shown or described in various embodiments may be mixed and combined with features shown in other embodiments.

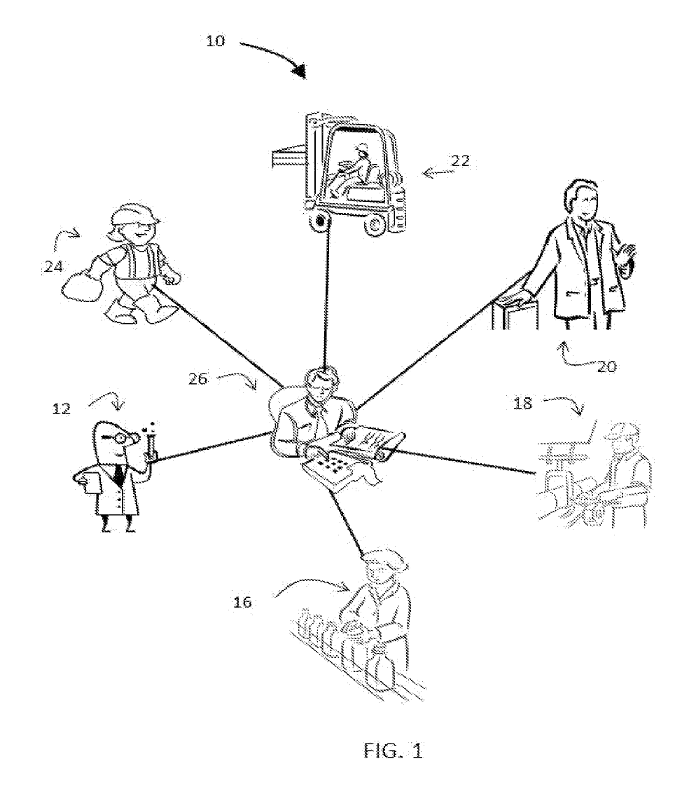

Refer now to FIG. 1 illustrating an exemplary business enterprise 10 having one or more individuals performing varied functions to contribute to the generation of revenues through the production and sale of products. These functions include product development and engineering 12, production 16, quality and compliance 18, marketing and sales 20, logistics 22 and service 24. Business enterprise 10 also includes management and human resource functions 26 that direct, evaluate and compensate individuals in the above listed functions. Within each function, such as manufacturing, are individuals and often teams or departments of individuals working to accomplish portions of these functions. The exemplary business enterprise has multiple projects engaging one or more functions and multiple individuals at any given time. Some projects, such as the manufacture of existing products, may run for years or decades while others, such as development or introduction of new product, product improvement projects, completion of work orders or special contracts may be completed in days, weeks or months.

Overlaying these projects are large and small processes and subprocesses used routinely by the various functions of the business enterprise 10 to implement repeated categories of activities. Large processes may include, for example, a new product process including subprocesses for development, funding, market research, product clearances, engineering handoff to manufacturing, and product launch. Another exemplary large process may be a payroll process which includes subprocesses for collecting payroll information, compensating employees, tracking bonuses, withholding taxes, 401K and other items, responding to court orders, and end of the year reporting of income and withholding. Smaller processes may include a process by which a specific production machine is operated, the process for reporting and responding to a manufacturing defect, or the process for creating, completing and auditing work orders generally.

It will be appreciated that the steps required to complete a project constitutes a process as well. Therefore, for purposes of the balance of this description, and the claims that follow, the term “process” will refer generically to any project or any process intended to be implemented by an enterprise, whether it is used only once, used repeatedly or even used continuously, whereas the term project shall be used more specifically to refer to a collection of steps in series and/or parallel that have a general beginning, and are expected to have an ending resulting in a specific output or set of outputs, some of which is generally defined at the beginning but may evolve over time as the project continues.

Within these projects and processes, various departments, teams and individuals will have assigned steps, activities, tasks, accountabilities and opportunities for involvement that affect the efficient, productive, timely and profitable completion of the project or furtherance of the process. Benchmarks may exist or may be developed for the quality, time, cost, or other attributes of these steps, activities, tasks, accountabilities.

Each project, process, task and accountability presents an opportunity for the participant to contribute to or adversely affect the success of the enterprise. Each also offers one or more opportunity to measure either directly or indirectly the quality and productivity of the participants' contributions. Such measures may include measurement of the participant's activity, measurement of the immediate output of the participant, measurement of the impact of the participant on those upstream or downstream of the participant in the process or project, and measurement of the attitude or behavior of the participant. Such measures may also include team measures that the participant shares with coworkers in the process or project.

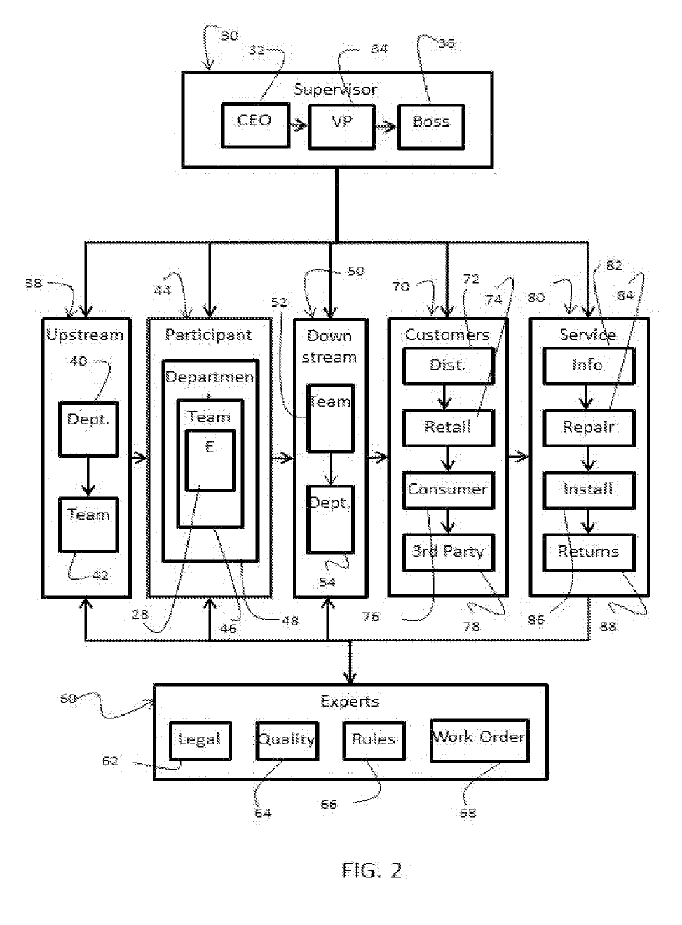

FIG. 2 graphically depicts the various participants and interested parties involved in exemplary projects or processes at exemplary business enterprise 10. There are typically one or more persons, generically referred to as “Supervisors” or “the Boss” herein, with high level accountability, for the implementation of the project or process, such as an immediate supervisor or boss of a direct participant, and one or more high level managers to whom the immediate supervisor reports, such as a VP and CEO. As there may be multiple direct participants, and even multiple participants in multiple enterprises, involved in carrying out the project or process, there may be supervisors in different management chains each having some accountability for the outcome of the project or process.

In addition to Supervisors, there are various departments, teams and individuals who are direct participants or workers in the process or project, who may sequentially, simultaneously and/or periodically handle their portion of the work. For example, engineering may hand a product design over to manufacturing and manufacturing may hand a produced product to logistics for delivery. Similarly, along a production line, one worker having performed one manufacturing operation may be passing work in process to another worker for performing another manufacturing operation. Therefore, with respect to almost any participant whose work is to be evaluated, there are typically upstream participants and downstream participants in the process or project who may be part of a different department or even a different enterprise or may instead be part of their own team.

At various points in time along projects or processes, there are experts who may set standards, take measurements against standards, audit compliance with standards and/or accept or reject the work performed or output of a participant. These experts include legal, regulatory, compliance or quality departments of the enterprise employing the participant or representatives of another enterprise having an interest in the work meeting a standard or requirement such as a government agency, a customer, or an independent standard agency.

Ultimately, the output of the project or process reaches one or more type of ultimate or intermediate customer, such as a distributor, a retailer, an acquiring consumer, or a third party beneficiary of the output.

At some point, not shown if FIG. 2, the output of the process may reach a Service provider, such as an installer, an information hotline, an answering service, and/or a repair person.

Any of the individuals or functions described with reference to FIGS. 1 and 2 may be employees, teams of employees, subcontractors, or external enterprises. Each has some interest in the performance by the participant at the center of FIG. 2, but ultimately the Supervisor is accountable for defining the performance requirement of the Participant and managing the Participant to produce the desired performance result. The present disclosure provides exemplary systems allowing the Supervisor to take advantage of the interests, observations and experiences of these other participants in a process and project, as well as the tools used by many of them, to define measure and reward the central participant in a manner that incentivizes optimum productivity.

As used herein, the measure of “productivity” is a measure of the level of performance of a participant in a process or project in delivering results according to the quantifiable standards defined in advanced by a Supervisor.

To be clear, management has had in the past many tools to identify what it wants from employees, to grade them on delivering on those expectations, to communicate those grades, and to make employment and compensation decisions based on those grades, but in practice, the employee gets little or late feedback, the employee does not clearly know in advance what they will be graded on or how the grade will be determined and what the consequences will be of the grade. Typically, there is little standardization across different supervisors or employee groups. Often, the communication of the grade and any reward or consequence of an appraisal occurs so remote in time from the performance that it has a weak effect on future performance. In some cases, the grading is entirely subjective and therefore not trusted by the employee as truly reflective of their performance. In some organizations, appraisals occur only on an annual or semi-annual basis and, the targets and goals on which the appraisal is based may not be written or agreed to until part of the period of time being appraised has already passed.

Such existing appraisal systems may be acceptable for long term management and for promotional and salary determination for professional positions in some business organizations, but they have a lesser value in affecting day to day prioritization, efficiency, quality and delivery of the issues most important to a supervisor. They also fail to provide a continuing reminder and short term incentive for delivering on what the supervisor wants the most in day to day performance. Furthermore, these appraisal systems don't provide a mechanism for using the results of the appraisal to set benchmarks for future appraisals, nor do they take advantage of measures which may be automatically generated from electronic tools and databases that are already in place for other purposes.

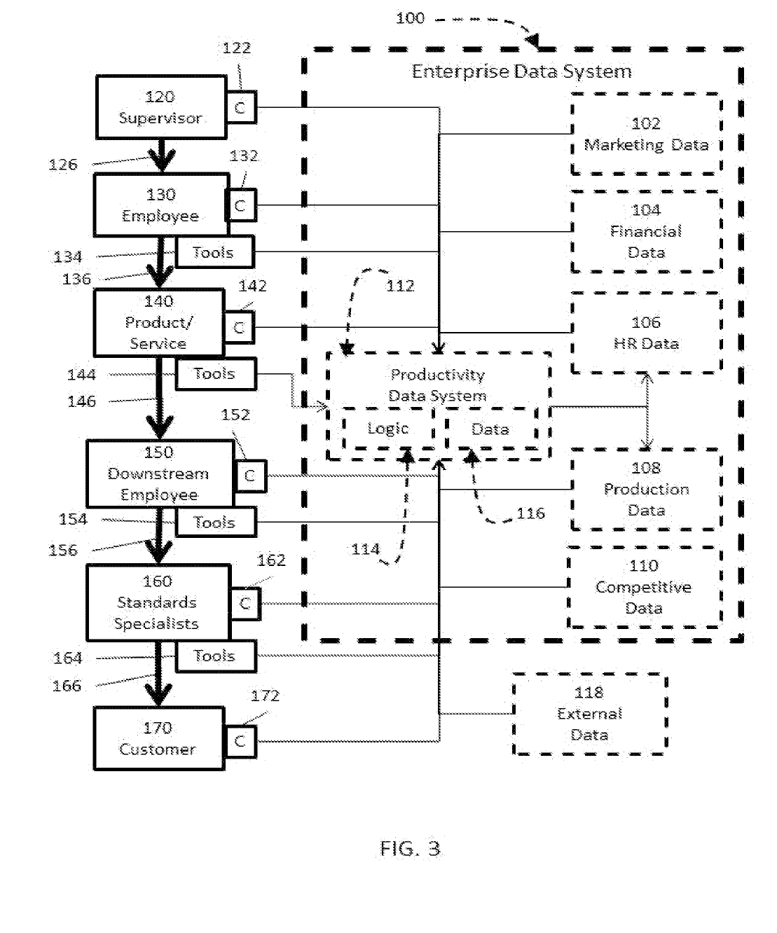

FIGS. 3 through 10 depict exemplary productivity systems and processes that remedy these deficiencies of prior systems. These productivity systems and processes generally include appraisal components and rewards components.

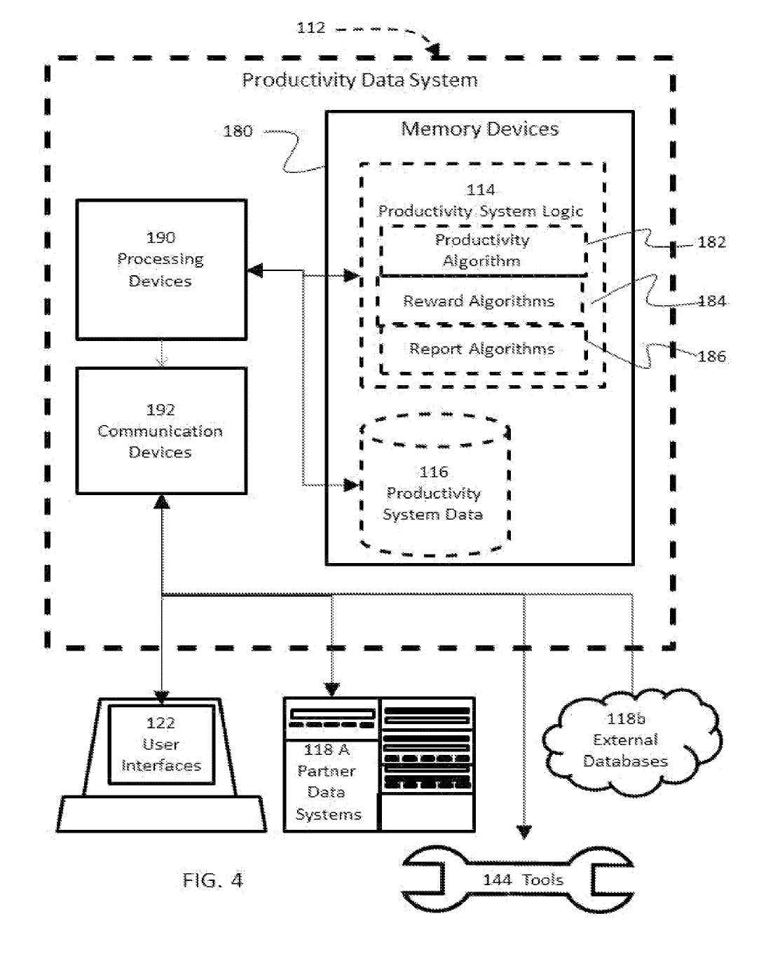

In particular FIGS. 3 and 4 depict a productivity system 112 having logic components 114 and data components 116 residing within the enterprise data system 100 (FIG. 3 only) As shown in FIG. 3, the enterprise data system has other data, logic and hardware components that work cooperatively with components of the productivity system including marketing data 102, financial data 104, HR data 106, production data 108 and competitive data 110, for example. The productivity system 112 can also communicate directly or through components of the enterprise data system 100 with external data 118, such as government, competitor, trade, or consumer provided data.

FIG. 3 also depicts certain human and distributed hardware components of productivity 112. This includes the people and groups of people and machines that participate directly or indirectly in performing processes within the enterprise, as well as tools used by these participants. In particular, productivity system 112 includes one or more Supervisors 120 who have accountability for a process, the computer or other data communication device 122 which they use to provide input to and retrieve information from the enterprise data system 100 generally and the productivity system 112 specifically.

Productivity system 112 further depicts a variety of direct participants such as upstream employees 130, production and service providers 140 and downstream employees 140 who are directly responsible for implementing steps in processes within the enterprise and are each accountable to one or more of the supervisors 120 for their performance. As indicated at 126. It will appreciated there may be multiple employees, teams of employees, full departments, non-employee subcontractors or other enterprises fulfilling these requirements as direct participants. Each direct participant 130, 140 or 150 may have a computer or other data communication device 132, 142 and 152 which they use to provide input to and retrieve information from the enterprise data system 100. Each direct participant 130, 140 or 150 may also have various tools 134, 144, and 154 which they use in implementing their steps in enterprise processes which may independently communicate with the enterprise data system 100 generally and the productivity system 112 specifically. Examples of these independent tools may be electronic measurement devices, phone systems which automatically track telephone calls, and factory machinery which tracks operations and/or controls line speed. Responsibility for implementation of steps in enterprise process advances sequentially from upstream employees 130 to Production 140 as shown at 136 and then to downstream employees 150 as shown at 146.

Productivity system 112 further may include standard specialists 160 who create, audit and/or enforce compliance with standards as well as their data communication devices 162 and tools 164 communicating with the enterprise data system 100 generally and the productivity system 112 specifically, and generally review aspects of the product or service created by the enterprise process after or as the direct participants 130, 140 and 150 have performed their steps in the process, as shown at 156. Finally, products or services resulting from enterprise processes pass, as shown at 166 to Customers 170 who may communicate about the product or service using their communication devices 172.

FIG. 4 provides an expanded depiction of the hardware and software components at the core of productivity system 112. In particular, productivity system 112 includes one or memory devices 180, which may be dedicated to the productivity system, may be shared with other portions of the enterprise data system 100, or may be dynamically assigned from time to time from a population of memory devices available for use by productivity system, such as cloud based systems. Memory devices 180 store productivity logic, such as productivity appraisal algorithms 182, reward algorithms 184, and report algorithms 186 as well as productivity data 116. Productivity system 112 also includes one or more processing devices 190 to implement the productivity logic and one or more communicating devices 192 to facilitate communication data to and from the various user interfaces, such as supervisor communication device 122, tools such as production tool 144, external databases such partner database 118a and other external databases 118b as well as other databases in the enterprise data system, not shown in FIG. 4. The processing devices 190 and the communication devices 192 may be dedicated to the productivity system, may be shared with other portions of the enterprise data system 100, or may be dynamically assigned from time to time from a population of memory devices available for use by productivity system, such as cloud based systems.

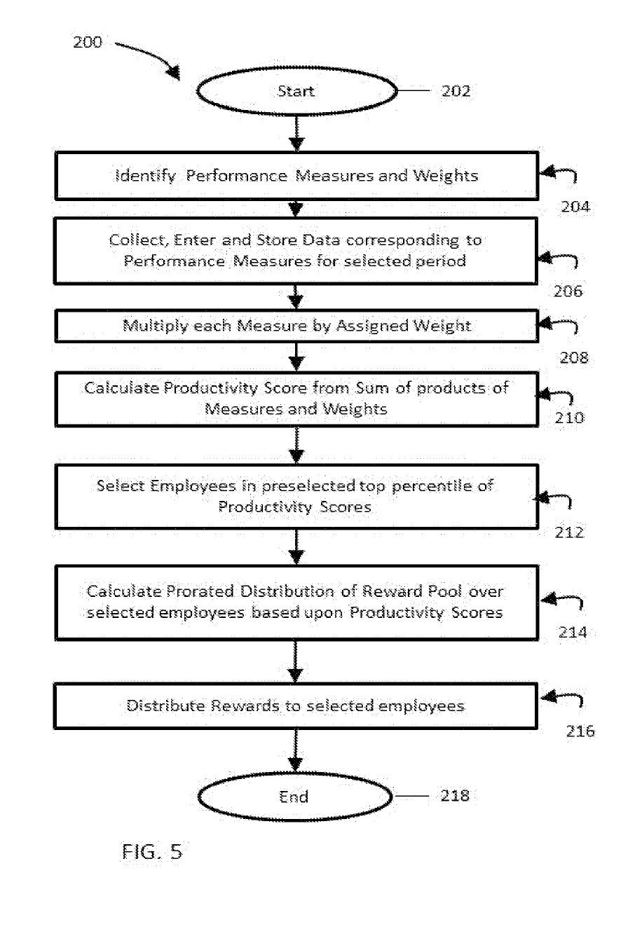

FIGS. 5 through 10 depict exemplary processes using and/or implemented by productivity system 112 of FIGS. 3 and 4 or similar systems.

In particular, FIG. 5 is a flow chart depicting general steps in an exemplary productivity data process 200 using the productivity system 112 of FIGS. 3 and 4. In particular, productivity data process 200 starts at 202 in order to appraise and reward participants in a selected manufacturing process, and more particularly participant in a specific step in the selected process. At Step 204, a supervisor, or someone working on behalf of a supervisor, identifies a performance measures or criteria applicable to the process, step or employee being appraised and important to the supervisor in assessing productivity. For example, for an assembly line employee implementing steps in a production process, the supervisor may identify measurements of cycle times, rejected parts, and absenteeism among the performance criteria of importance and may assign them weights of, for example, 3, 5 and 1, respectively. Some performance measures may be shared by all process participants on a team, some may be common to multiple team members but may be calculated separately for each member, and some may be uniquely applicable to only certain team members.

At step 206, implemented as or after the manufacturing operation is performed, data representing performance against the criteria is collected and/or entered and saved over a selected period of time, such as over a pay period of the participants. At step 208, each performance measure is reduced to a single number for the selected period of time and multiplied by the weight assigned for such measure. The single number may be a single measurement or number entered by an observer, such as a count of rejects, or may be calculated from multiple entries, such as an average of cycle times calculated from several cycle time measurements. At step 210, the several products of measures and their weights are summed to create a single Productivity Score for each participant in the manufacturing process which are compared at 212 to appraise the relative productivity performance of these participants. The participants with the highest Productivity Score are selected to participate in a prorate share in a bonus pool at Step 214. At Step 216, the bonus pool is automatically distributed to the highest Productivity Score Employees and the process ends at step 218.

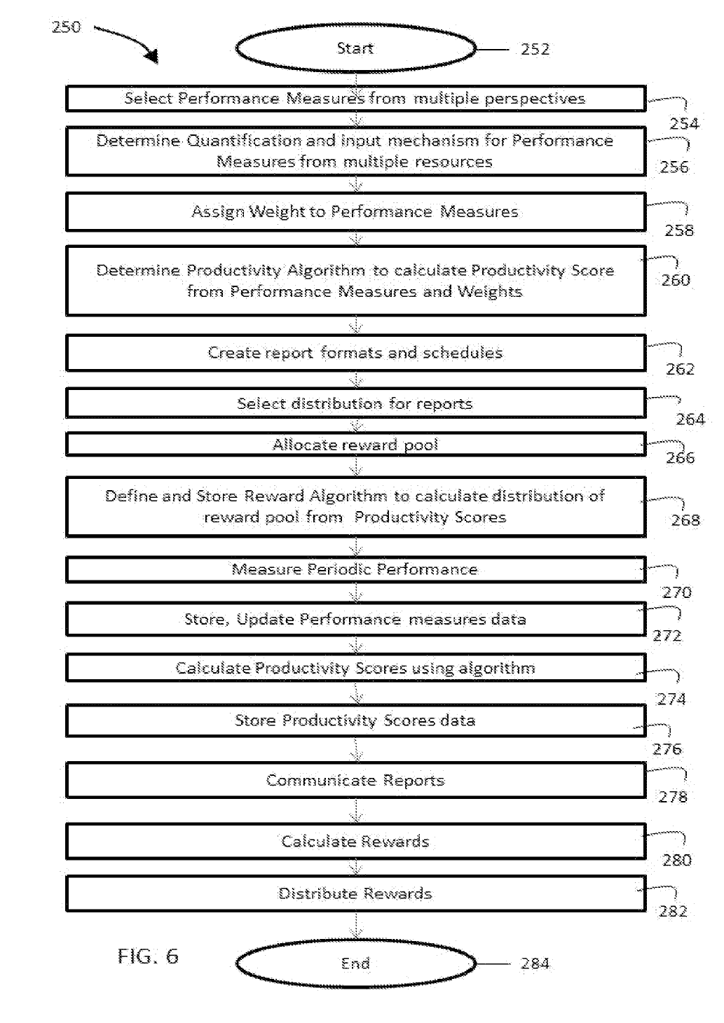

FIG. 6 is a flow chart depicting steps in an alternative exemplary productivity data process 250 using the exemplary productivity system 112 of FIGS. 3 and 4.

In particular, productivity data process 250 starts at 252 in order to appraise, reward and provide feedback employees in a common department. At Step 254, a supervisor, or someone working on behalf of a supervisor, identifies a performance measures or criteria applicable to each employee being appraised and important to the supervisor in assessing productivity by consulting other stakeholders, such as upstream and downstream employees, experts, and customers. Some performance measures may be shared by several employees who are in a common process or team, some may be common to multiple employees but may be calculated separately for each employee, and some may be uniquely applicable to only certain employees.

At step 256, a method is determined for each selected performance measure to reduce it to number. For objective measures, this may involve direct use of the number measured. However, for subjective measures, or for measures which differ from employee to employee, a method is selected to identify a scaled number that be more easily and fairly compared with others in the bonus pool. For example, the method might be to assign a number from 1 to 10 or a percentage to the measure based on identified objective calculation or subjective consideration. At step 258, a weight is assigned to each productivity measure. Employees having identical accountabilities relative to a given measure may all have the same weight assigned, while employees having different accountability or control over a measure, or for whom the measure represents a different portion of their job responsibility, may have a different weight.

At step 260 an algorithm is defined for converting the productivity measures and weights to Productivity Score. The simplest algorithm, as described for productivity process 200, is to compute a sum of the products of each productivity measure and its respective assigned weight, but other algorithms may be chosen based on an assessment of what is fair and appropriate. For example, for employees who move between various assignments which are measured by different performance measures, the calculation may involve multiplying each performance measure by its respective weight and by the percentage of time spent on the relevant assignment. Other examples would include algorithms that account carefully for the occurrence of zero or negative measures, as well as algorithms that account for exceptional good or bad results of single measure which might warrant a different final score.

At step 262, reports of various kinds are defined for outputting data to various stakeholders in the performance of employees and enterprise processes. The formatting of such reports may be creating using other portions of the enterprise data system, such as Word, PowerPoint, EXCEL and other report creation software. Examples of these reports include charts comparing performance of various employees and teams, graphs showing change over time of various measures and of composite and productivity scores, and form messages to various participants and stakeholders in processes being measured regarding status, quality and/or productivity. Other examples are described later herein. Also, the timing of these reports and of the calculation and award of bonuses is set at step 262. At step 264, the distribution methods and destinations are selected for reports using software dedicated to productivity system 250 or using enterprise data system software such as email software. Reports may be sent as email attachments, posted to internal or external websites or delivered directly to dedicated display hardware viewable by the employees. At step 266, a periodic award pool or a method of creating a reward pool is set. For example, the pool may be a preset amount or may be a percentage of the revenues or profits earned by the enterprise during the bonus period.

At step 268, the algorithm for determining the distribution of the bonus pool is established, including a method for determining which employees participate in the pool and a method for calculating the amount that each participating employee collects from the bonus pool. For example, the bonus may be distributed prorate to all eligible employees, those employees in some top percentile, or those with productivity scores above a certain level. The calculation may be prorate, based on productivity score, as in exemplary process 200, or by some other formula. The algorithm may, provide other features, if desired, such as allow for occasional or token participation of new employees at a lower score level if they are showing a rapid rate of learning and improvement, or excluding employees who are on probation.

Raw data for performance measures are periodically harvested at step 270 and performance measures are stored and updated at step 272. Productivity Scores for employees are calculated at step 274 from the Productivity Algorithm and stored at step 276. Reports are generated and distributed at step 278. Finally, the rewards, including bonuses, are calculated from the Bonus Algorithm at step 280 and distributed at step 282, with the process ending at step 284.

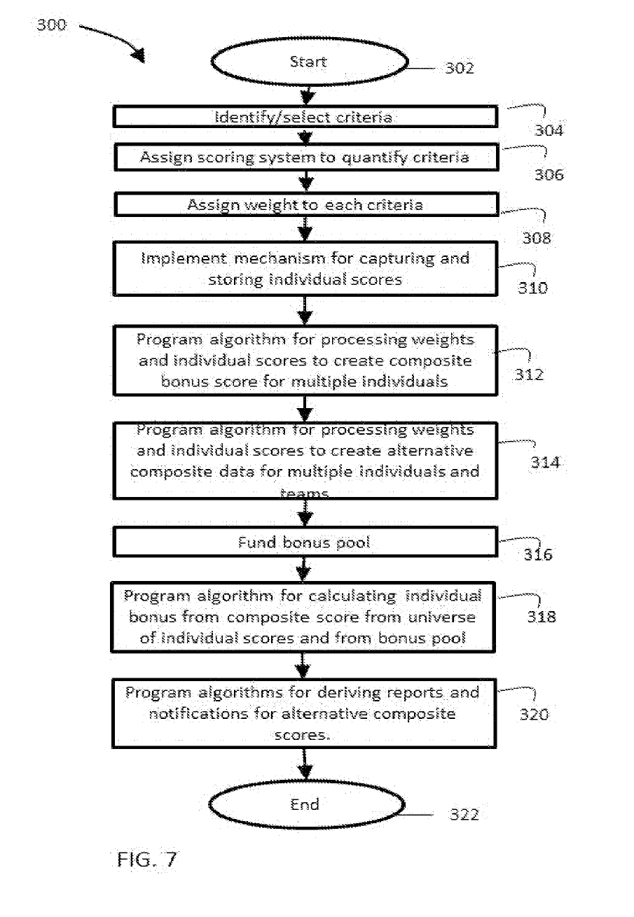

FIG. 7 depicts steps in an exemplary productivity data initiation process 300 using the productivity system 112 of FIGS. 3 and 4, a subprocess of still another alternate productivity process. The process 300 of initializing a productivity system 112 starts at step 302. At step 304, appraisal criteria, such as productivity performance measures, are identified or selected from a preprogrammed set of choices for each employee. At step 306, a scoring system for quantifying the criteria is identified or selected from a preprogrammed set of choices. At step 308, a weight is assigned to each selected criteria for each employee or group of employees. At step 310, a mechanism for capturing and storing individual measures is selected or created, such as data keyed in by an identified employee or third party, or data is pulled from a tool or database used by or available to the enterprise using process 300. At step 312, a composite score calculating algorithm is created or selected from a set of preprogrammed choices. At step 314 one more additional algorithm are created or selected from a set of preprogrammed choices for calculating other types of useful scores and composite data from the data collected by the productivity system and data from other sources accessible by the enterprise. At step 316, an account is funded for a bonus pool. At step 318, a bonus calculation algorithm is created or selected from a set of preprogrammed choices. At step 320, one or more algorithms for generating reports and notifications as well as distribution methods and lists are created or selected from preprogrammed sets of choices. The initialization of the productivity system stops at step 322.

FIG. 8 depicts steps in an exemplary productivity data management process 350 using the productivity system 112 of FIGS. 3 and 4, such as one that has been initiated by exemplary productivity data initiation process 300 of FIG. 7. The data management process starts at step 352 at the beginning of a bonus period. At step 354, measured data from around the enterprise, such compliance with specifications, speed of the assembly line, or count of phone calls is entered and stored. This measured data may be keyed in or read in automated fashion by a tool. At step 356, existing data is pulled from other databases, such as production data from the enterprise production database, sales data from the enterprise marketing database, attendance information from the enterprise HR database, or complaint information from a customer database. At step 358, the measured and existing data are processed to create some of the productivity measures which need to be calculated from one more of these categories of raw data. At step 360, quantitative data derived from subjective observation of stakeholders, such as upstream or downstream employees, experts or customers, is entered and stored as additional productivity measures. It should be noted that some productivity measures may reflect data from more than one bonus period, such as a moving average, recent maximum, recent minimum of data from several months.

At step 362, Productivity Scores and other useful composite data is calculated from the performance measures, which are stored at step 364. Once the data is collected and processed in steps 354-364, process 350 generates and communicates reports at step 366, sends email notices at step 368, exports useful data to other enterprise databases at step 370, and displays selected reports, such as graphical information or praise of high scoring employees, on monitors located near employees workstations, lunch rooms or other convenient locations at step 372. One of the notices at step 368 may be sent early in bonus period to inform all participants of the bus eligibility, how much is in the pool, and how they will be evaluated. As shown at step 374, the steps of gathering data, processing data, and distributing information repeat, as frequently as preferred until the end of the reward period. For example, the monitors receiving reports at step 372 may be updated hourly, while external databases may be updated at step 370 daily and email notices provided at step 368 as warranted by performance.

At the end of the reward or bonus period, the reward or bonus is calculated at step 376 and distributed at step 378. Other rewards, such as future time off with pay may also be calculated at step 376 and provided at step 378. Step 378 may be implemented by send a notice to the payroll portion of the enterprise HR data processing system so that a bonus is automatically paid with the next paycheck and/or eligibility for paid time off is recorded and acknowledged. At step 380, any supervisor or enterprise management generally has an opportunity at step 380 to modify algorithms, bonus pools and other aspects of the system before return to step 354 to repeat the process for the next pay period. In some instances, measures may be adjusted at this time to reflect management's learning's over one or more prior bonus period, or benchmarks may be adjusted to reflect recognition that benchmarks previously viewed as a stretch are now routinely hit.

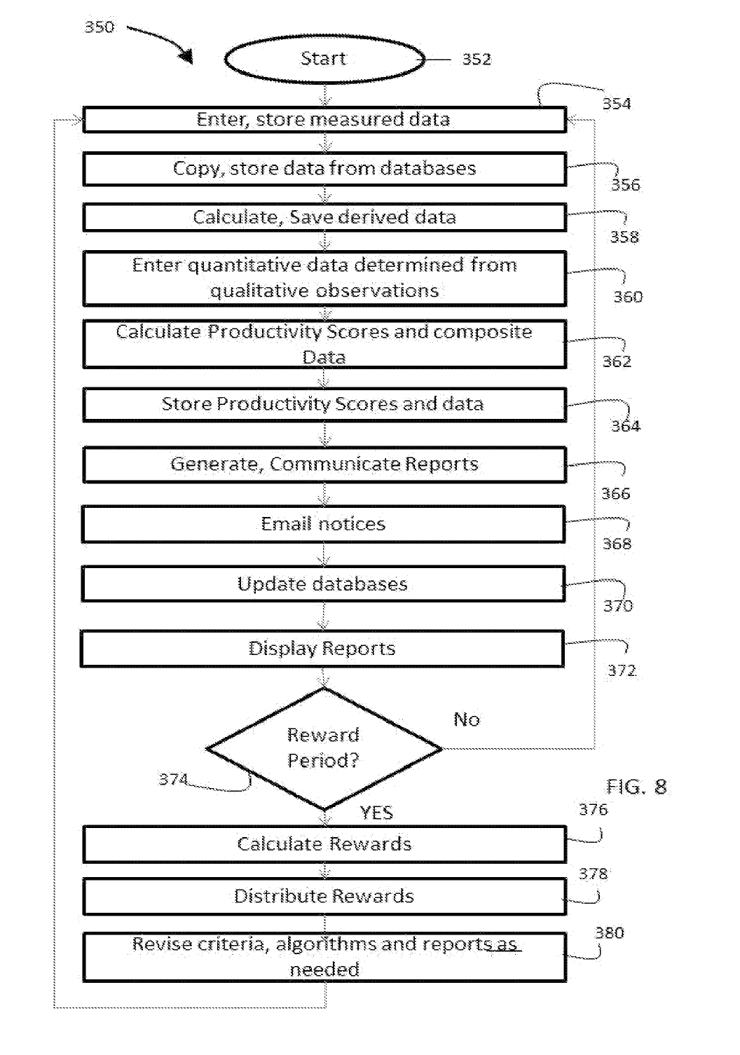

Referring to the productivity system component of FIG. 3 and the process of FIG. 9, FIG. 9 depicts steps in an alternative exemplary productivity data management process 400 using the productivity system 112 of FIGS. 3 and 4, which may be initiated by exemplary productivity data initiation process 300 of FIG. 7. The productivity data management process 400 starts at step 402 at the beginning of a bonus period. At step 404, production data required by process 400 is entered by participants 130, 140 and 150 of FIG. 3 in the production process, which may include data entered through production employee's data communication devices 132, 142 and 152 and/or data collected by their tools 134, 144, and 154. At step 406 on FIG. 9, marketing data required by process 400 is entered by marketing employees or read from enterprise marketing data 102 (FIG. 3) or derived from external sources 118 (FIG. 3). At step 408 of FIG. 9, quality data required by process 400 is entered by supervisors 120, downstream employees 150, standard specialist 160 or customers 170, their respective data communication devices 122, 152, 162 and 172 and tools 154 and 164 as well as from enterprise production data 108, external databases 118 and service and return reports and database, not shown. HR data required by process 400 is entered at step 410 from HR employees, not shown, supervisors 120 and from enterprise HR databases 106. Other required data is harvested from internal and external databases at step 412, carryover data from prior bonus periods used for comparison or long term measure is retrieved at step 414, and other tool data not described above is retrieved at step 416. Once all required data is entered, harvested, read and stored, Productivity scores and other composite data are calculated and reports are created and distributed at step 418.

It will be appreciated that the productivity systems described herein not only provide data of use in evaluating people, but also provides data about the tools these people use and how they are interacting with them in absolute, time dependent, relative or comparative terms. Instructions for modifications of operation may be delivered to tools at step 420. For example, quality and throughput data processed in step 418 may reveal a specific that a specific parameter of a tool should be modified to adjust the process. Examples may include changes in the speed of an assembly line, the temperature of an operation. Similarly, users of the tools may receive suggestions for modifying their use of tool, asked to inspect and perhaps retire or sharpen a cutting tool, for example, based on the data processed in the productivity system 112. This may be included in the reports displayed and/or communicated in step 422. Furthermore, as depicted in step 424, information processed by productivity system 112 may result in a notice to a participant or stakeholder requiring action to be taken at step 426 such as immediately stopping an assembly line or pulling an employee from his workstation.

As shown at step 428, the steps of gathering data, processing data, and distributing information repeat, as frequently as preferred until the end of the reward period. At the end of the reward or bonus period, the reward or bonus is calculated at step 430 and distributed at step 432 and the process 400 returns to step 404 to begin gathering data for the next reward period.

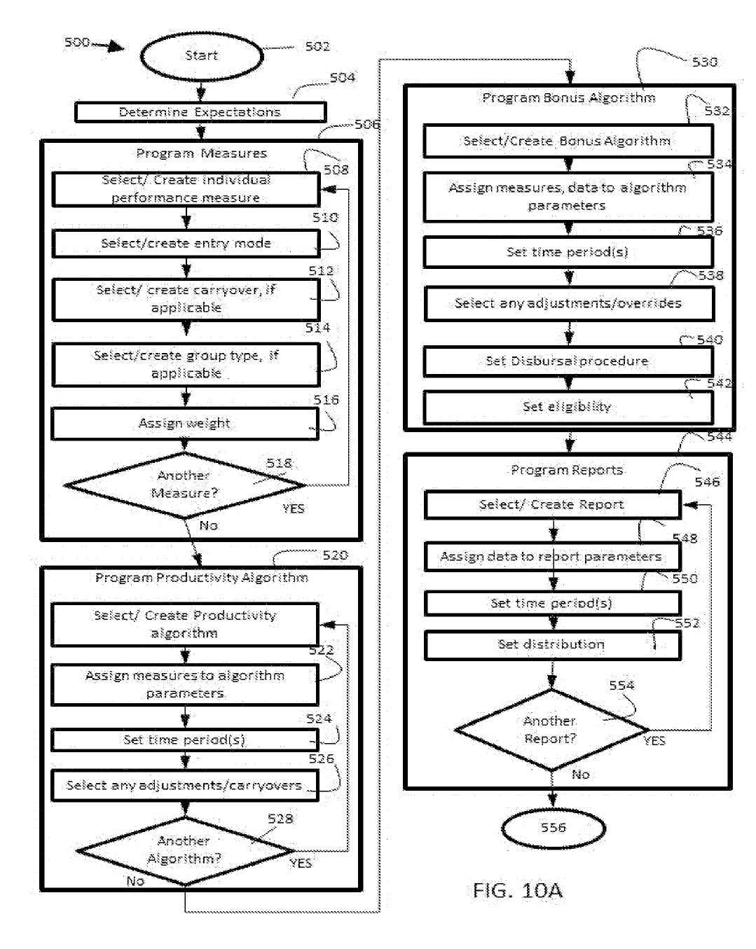

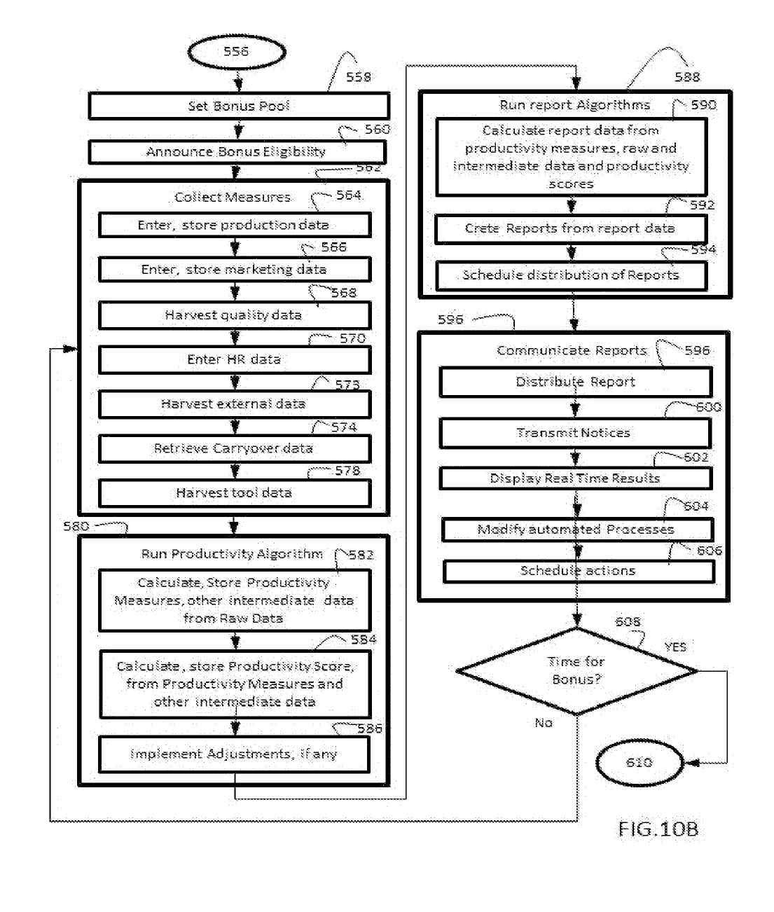

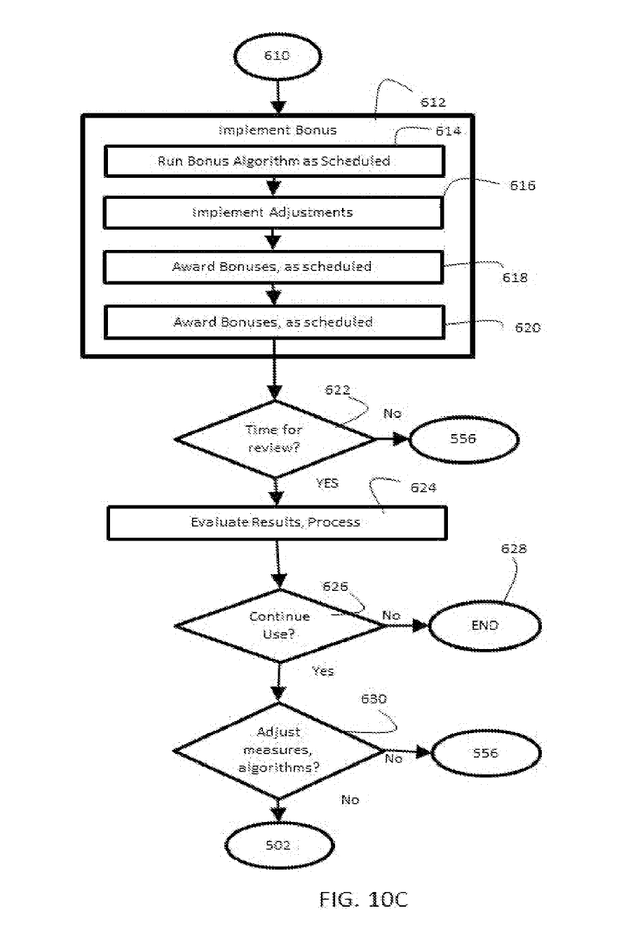

FIGS. 10A, 10B and 10C depict a flow chart depicting steps in an alternative exemplary productivity data process 500 using the productivity system 112 of FIGS. 3 and 4. In particular, process 500 is modular in design to facilitate staged upgrading of the modules as well as to permit distributing individual modules at desired locations around an enterprise as warranted by the diversity and growth of the enterprise. Furthermore, the modular format of process 500 facilitates user modification at any time of a desired specific set of parameters, such as adding measures, algorithm, jobs, or employees.

Productivity process 500 starts at step 502 when an enterprise chooses to implement the process to assess and reward at least a portion of its employees. At step 504, stakeholders, especially supervisors, are provided with an opportunity to provide input on performance measures they believe are available and/or they view as important for assessing the productivity of employees generally or employees in specific jobs or assignments.

Next, subprocess module 506 is implemented to program into process 500 the productivity measures. In particular, subprocess module 506 includes step 508 creating or selecting a performance measure, step 510 selecting or creating an entry mode for the measure, step 512 selecting or creating a mechanism for carrying over a measure from one bonus period to another, if desired, step 514 selecting or creating one or more group type to assign the measure, step 516 assigning a weight to the measure and step 518 repeating subprocess 504 until all of the measures have been created for the job or jobs which are intended to participate in the bonus pool. Subprocess module 506 may vary from enterprise to enterprise using process 500 for example by having different preprogrammed sets of measures applicable to the jobs of interest to the enterprises and/or having no capability or different capabilities for communicating with the enterprise data system overall for seeking out existing data categories and existing measurements available from tools around the enterprise for supplying data from which performance measures may be obtained.

Next subprocess module 520 is implemented to program into process 500 productivity algorithms for calculating productivity scores from productivity measures. In particular, subprocess module 520 includes step 522 creating or selecting a productivity algorithm, step 522 assigning productivity measures to the productivity algorithm, step 524 setting the time period or frequency for repeatedly recalculating the productivity score, step 526 setting any adjustments, carryovers or other additional operations to be performed beyond the selected or created algorithm, such a adjustments for negative scores, adjustments for extreme results, or adjustments for layoffs and holidays during bonus periods, and step 528 repeating subprocess 520 until algorithms have been created for all desired jobs or employees. Subprocess module 520 may vary from enterprise to enterprise using process 500 for example by having different preprogrammed sets of algorithms applicable to the jobs of interest.

Next subprocess module 530 is implemented to program into process 500 the bonus algorithm. In particular, subprocess module 530 includes step 532 creating or selecting a bonus algorithm, step 532 assigning measures scores and other data to algorithm parameters, step 534 setting the timing or frequency of bonus calculation, step 538 setting an adjustments or overrides for bonus calculation or award, step 540 setting the disbursal procedure for bonus awards and step 542 setting eligibility for participation in the bonus pool. Subprocess 530 may also be repeated if multiple bonus pools are being established. Subprocess module 530 may vary from enterprise to enterprise using process 500 for example by having different bonus algorithms, having capability to handle only one or multiple bonus pools. Subprocess module 530 may also differ from enterprise to enterprise in its capability to communicate with other enterprise software to automatically pay bonuses. Subprocess module 530 may also vary in providing additional non-monetary rewards to employees based on performance scores.

Next subprocess module 544 is implemented to program reports and notifications into process 500. In particular, subprocess module 544 includes step 546 creating or selecting a report, step 548 assigning measures, scores and other data to report parameters, step 550 setting the timing or frequency of reports, step 552 setting distribution of reports and step 554 repeating subprocess 544 until all desired reports and notifications have been completed. Subprocess module 544 may vary from enterprise to enterprise using process 500 for example by having different reporting capabilities including different forms, report software, and distribution capabilities.

After measures, algorithms and reports have been set, at step 536, one or more bonus pool is established at step 558 and bonus eligibility is announced to the enterprise at 560.

Next subprocess module 562 is implemented to collect productivity measures. In particular, subprocess module 562 includes step 564 through 478 entering or harvesting, respectively, production data, marketing data, quality data, HR data, external data, carryover data and tool data, selected for collection under subprocess 506. Subprocess module 562 may vary from enterprise to enterprise using process 500 for example by having different communication capabilities for gathering data.

Next subprocess module 580 is implemented to run the productivity algorithm or algorithms. In particular, subprocess module 580 includes step 582 calculating and storing any intermediate data needed for calculating productivity scores or providing other data for later reporting, step 584 calculating productivity scores and step 586 adjusting any scores, if needed, based on adjustments selected previously in step 526.

Next subprocess module 588 is implemented to run the report algorithm or algorithms. In particular, subprocess module 588 includes step 590 calculating and storing report data, step 582 creating reports or notifications, and, step 594 scheduling distribution of reports.

Next subprocess module 596 is implemented to communicate reports and notifications. In particular, subprocess module 596 includes step 598 distributing reports, step 600 transmitting notifications, step 602 displaying real time results, step 604 modifying automated processes in view of the data collected, and step 606 scheduling future actions, such as employee meetings. Subprocess modules 580 and 588 may vary from enterprise to enterprise using process 500 for example by having different communication capabilities for distributing reports and notifications.

At step 608, if it is not yet time to award bonuses, operation is returned to subprocess module 562 to continue to collect measures and to module 564, 588 and 596 to continue to run productivity, and report algorithms. When the time arrives for bonus calculation, at step 610, operation passes to subprocess module 612 to implement the bonus award. Subprocess module 612 includes step 614 running the bonus algorithm, step 616 implementing any adjustments selected previously in step 538, step 618 awarding bonuses and step 620 providing any announcements or celebrations deemed appropriate. Subprocess module may include implementation of other forms of reward or recognition as desired.

At step 622, operation is returned to step 556 to begin the repeat the steps and subprocesses for a new bonus period, unless it is time for a process review, in which case operation moves to step 624 to begin a review of the operation and parameters of process 500. At step 626, a decision is made to continue using process 500 or stop. If the process is to be continued, then a decision is made a step 628 to either resume using the process without modification at step 556 or to modify the process parameters and return to step 502. In operation, a review and an adjustment of future measures and algorithms may be ongoing even as the process continues to implement the appraisal and reward portions of the process for a current bonus period.

It will be appreciated that each of the productivity processes described herein may be reflected in one or more software components of a productivity system residing in a single computer or dispersed across the enterprise or network, as generally depicted in FIGS. 3 and 4. It will also be appreciated that components of the various systems and process described throughout this disclosure may be mixed and matched with components of other systems and processes described herein to form a process or system of the desired complexity and robustness for the enterprise using it. Furthermore, while much of the exemplary description has been provided in the context of a product manufacturing environment, it will be appreciated that the processes and systems disclosed herein may advantageous used for any employees, any process and any enterprise where it is desirable to measure reward productivity by identifying appropriate productivity measures. For example, in service operations, number of contacts and satisfactory resolutions of complaints may be among the performance measures. In organizations of professionals such as attorneys and accountants, especially within a corporation, a charity or in government enterprise where there is no direct billing of clients that may be used for measuring productivity, it will be appreciated that production measures may include objective counts of dispositions of various types, turnaround time, client satisfaction as well as various subjective measures.

It will be appreciated that the performance systems described herein collect and process a lot of data that may be used for additional purposes within the enterprise. For example, the data may be used to determine who is the best employee to assign to a specific task or project, to estimate the cost of the project, or to evaluate the productivity of teams, departments, factories, and tools and equipment used by the enterprise.

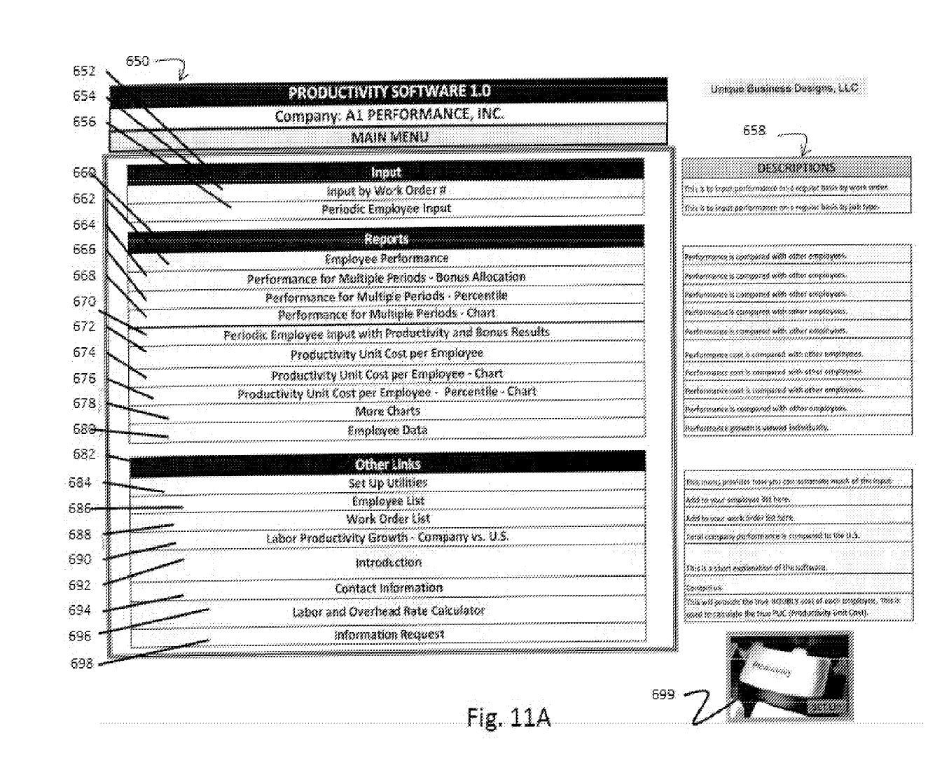

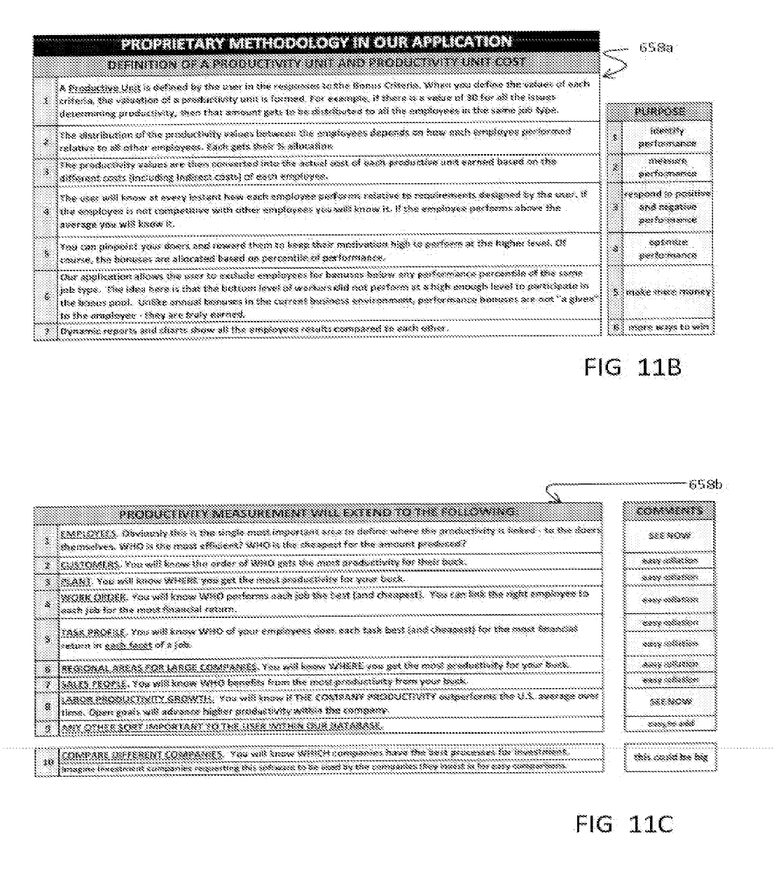

Referring now generally to FIGS. 11-40, an exemplary productivity system 112 is embodied in an EXCEL workspace residing on one or more computer is depicted through screen shots. In the example described below, as in those described above, the enterprise using the productivity system is a manufacturer and many of the features and components of the system are described in connection with manufacturing projects and jobs. In particular, the system depicted in FIGS. 11-40 applies to an enterprise where much of the work is done in response to individual work orders or projects. It will be appreciated by these skilled in the art that this productivity system may be used for any type of enterprises, any type of output, any types of enterprise process and any category of employee.

FIG. 11 depicts a main menu 650 for initiation use of the productivity system which may reside, for example, on a worksheet named Main Menu or Start as well as from hyperlinks appropriately located throughout the workspace. The menu allows selection of categories for input 652 such as Input by work Order 654 and Employee Input 656. Selection of any of these choices will link the user to an input form for entering the relevant information. Many menu items are provided with textual explanations 658 such as definitions or further information.

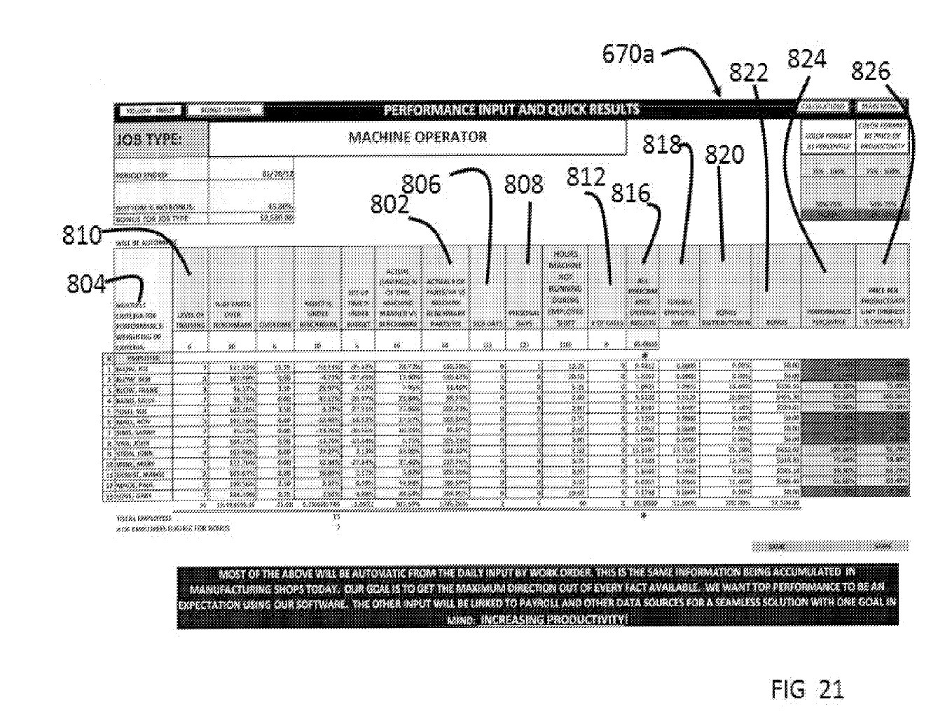

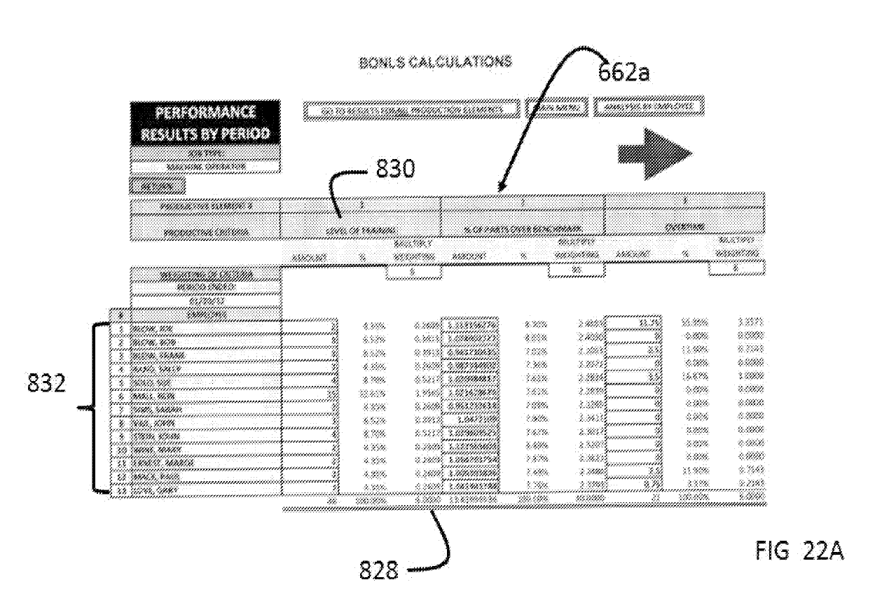

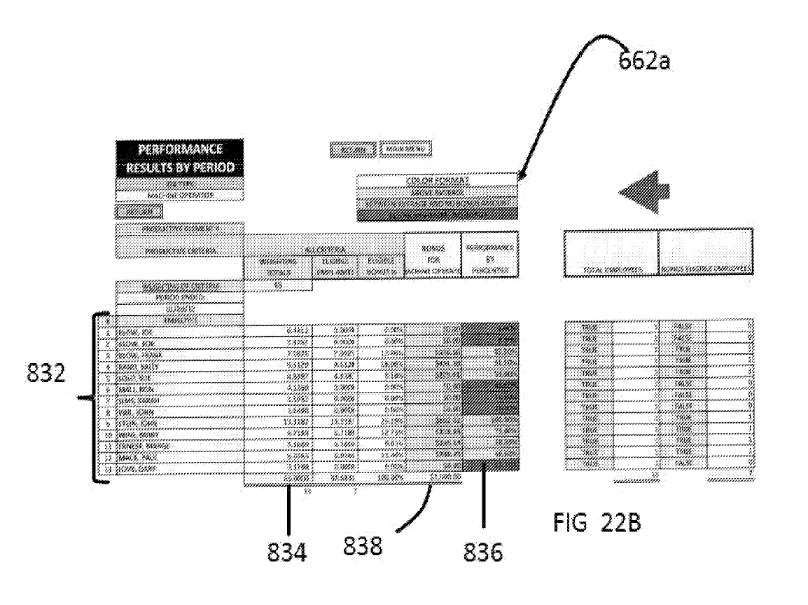

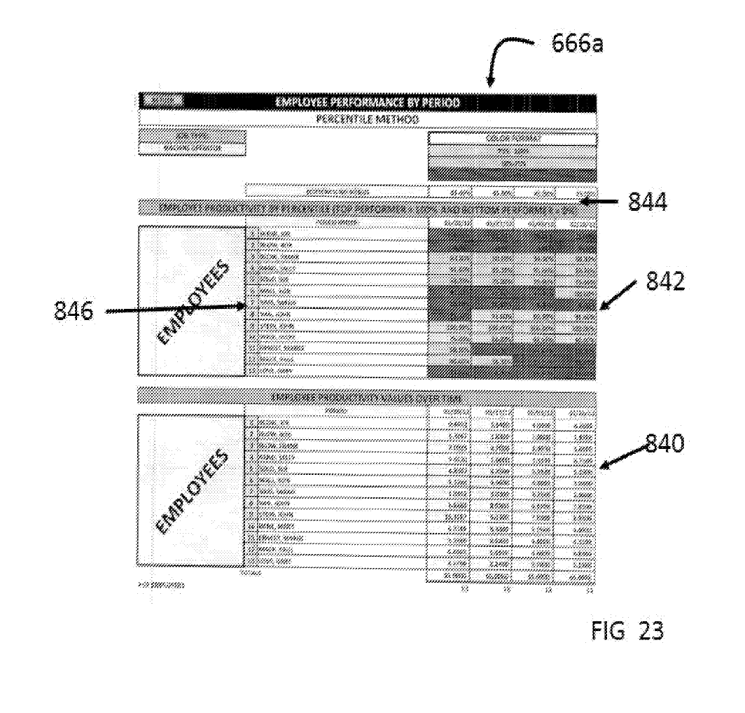

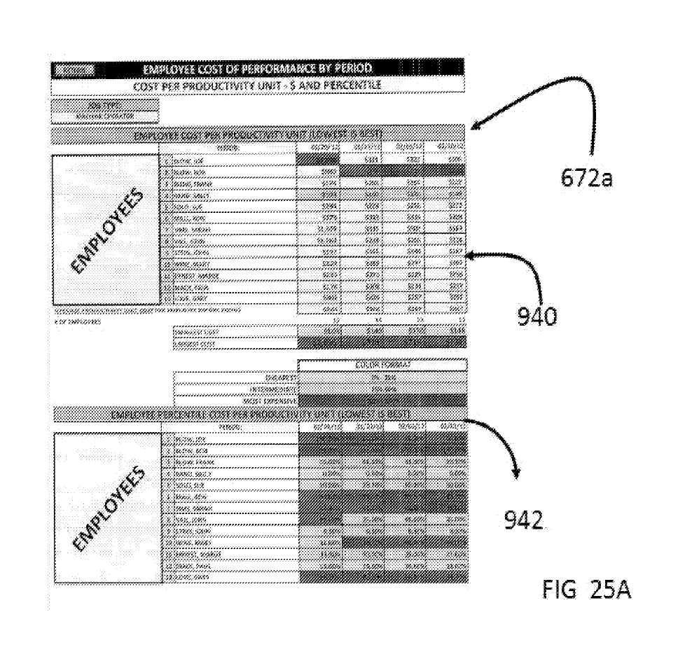

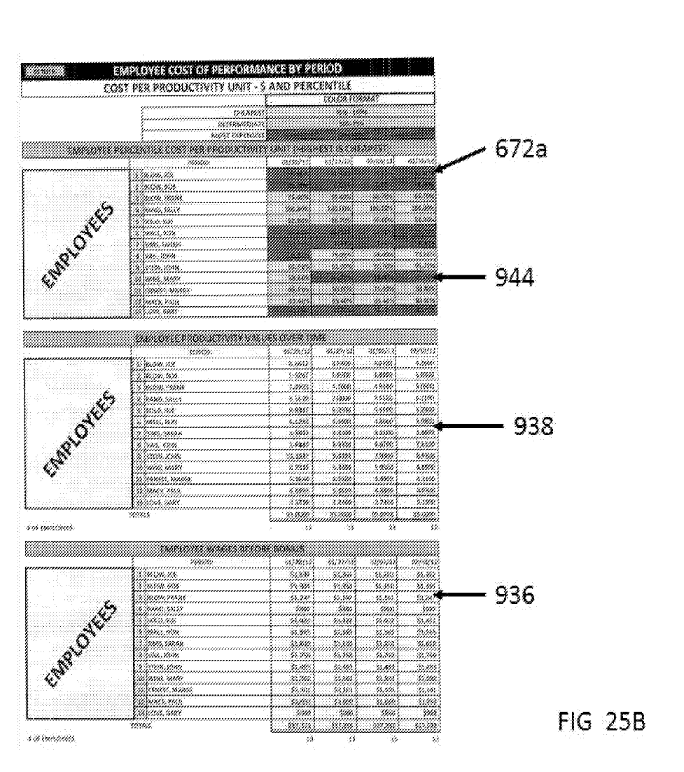

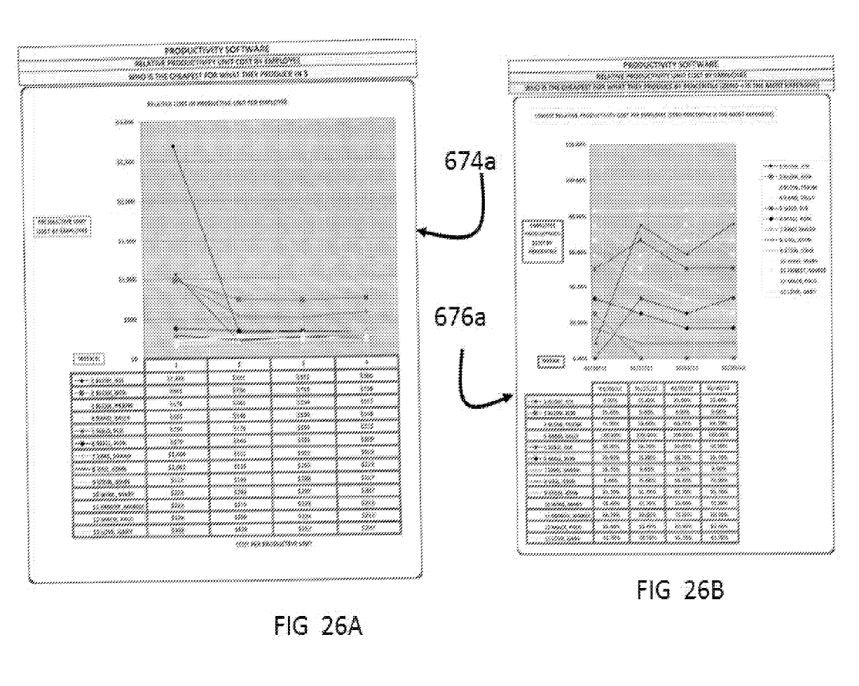

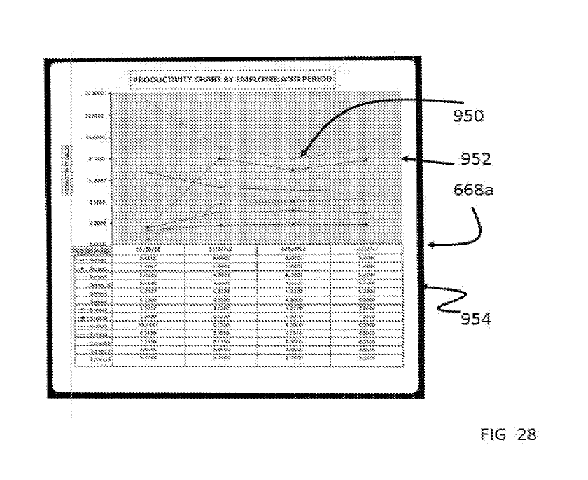

Main Menu 650 also includes selection of links 660 to reports such as Employee Performance 662, linking to the chart 662a shown on FIGS. 22A and 22B, Performance for Multiple Periods—Bonus Allocation 664 linking to the chart 664a shown on FIG. 23, Performance for Multiple Periods—Percentile 666 linking to the chart 666a shown on FIG. 23, Performance for Multiple Periods—Chart 668 linking to graph 668a shown on FIG. 28, Periodic Employee Input with Productivity and Bonus Results 670 linking to the chart shown 670a on FIG. 21, Productivity Unit Cost per Employee 672 linking to the chart 672a shown on FIGS. 25A and 25B, Productivity Unit Cost per Employee Chart 674 linking to the graph 674a shown on FIG. 26A, Productivity Unit Cost per Employee Percentile Chart 676 linking to the graph 676a shown on FIG. 26B, respectively, More Charts 678, and Employee Data 680.

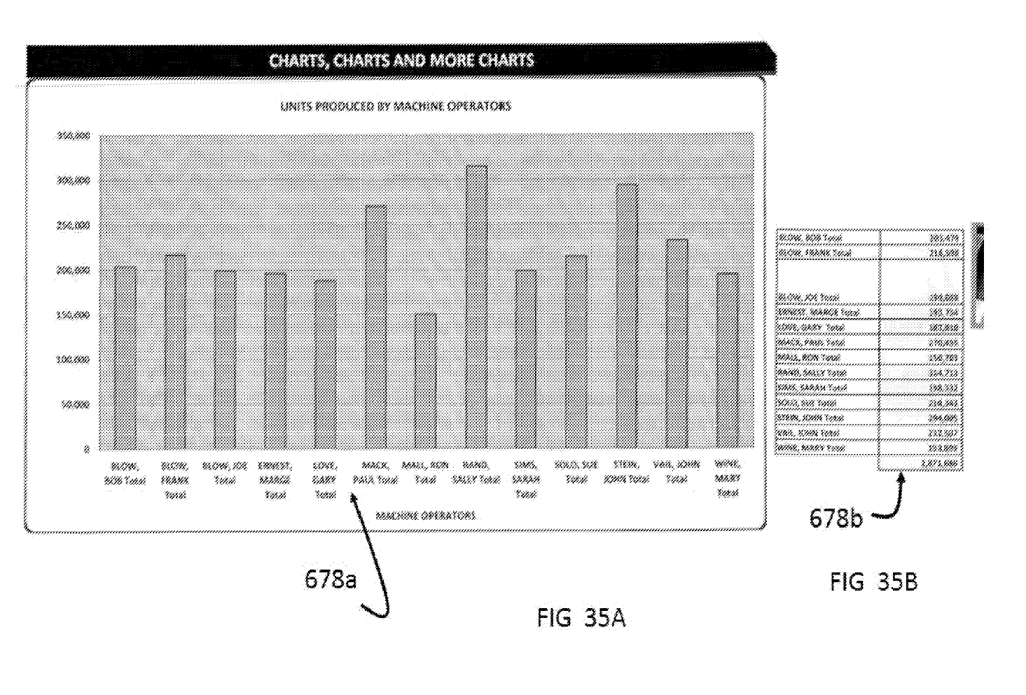

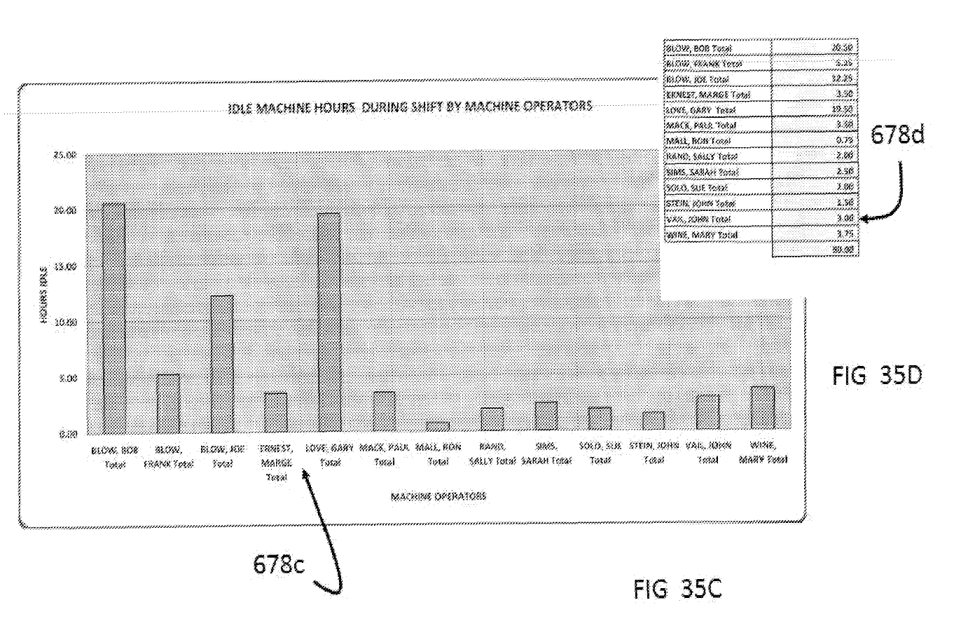

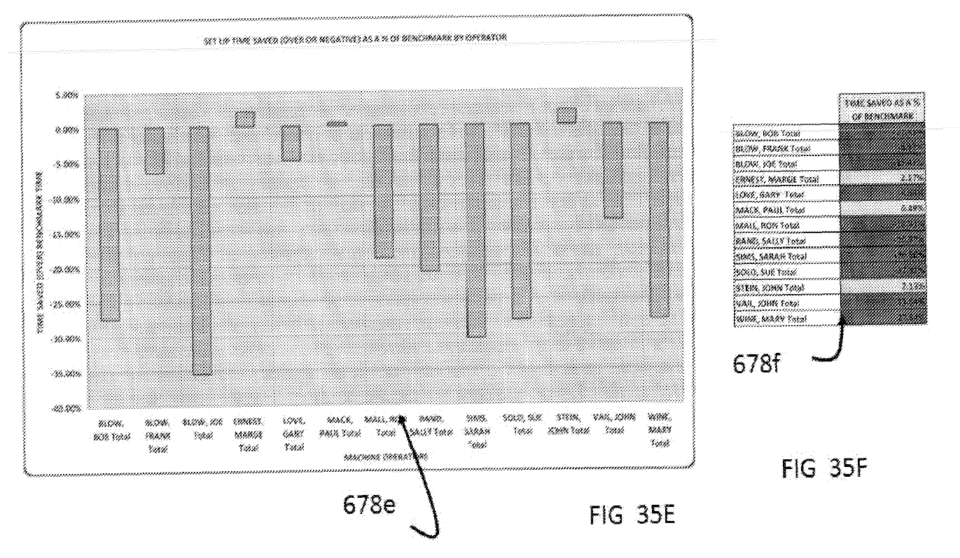

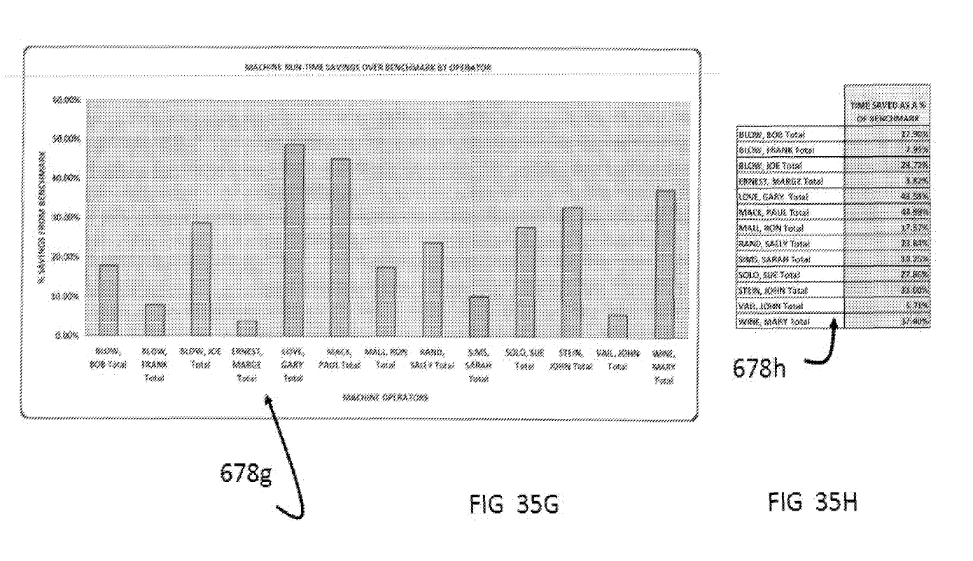

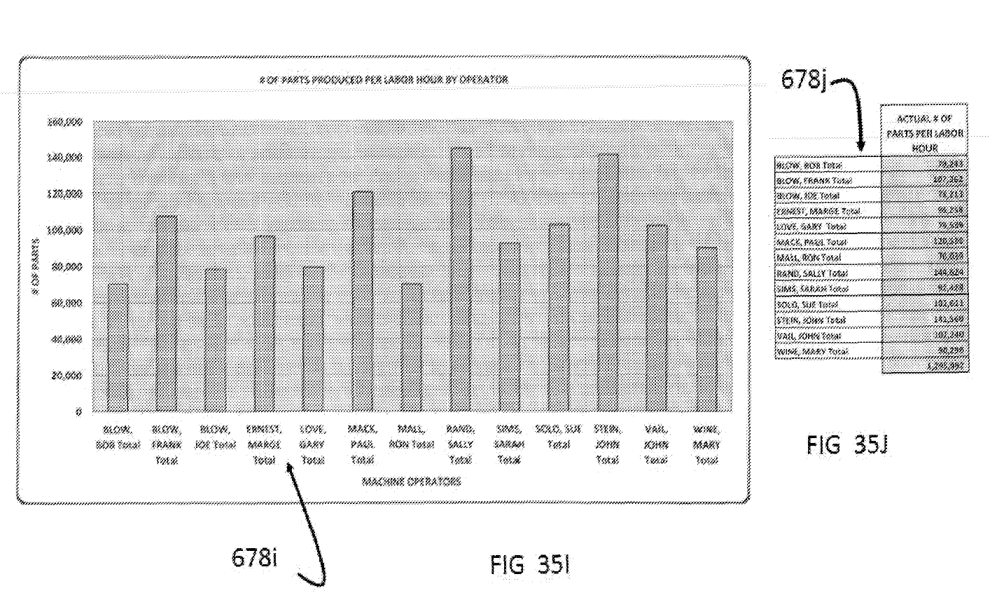

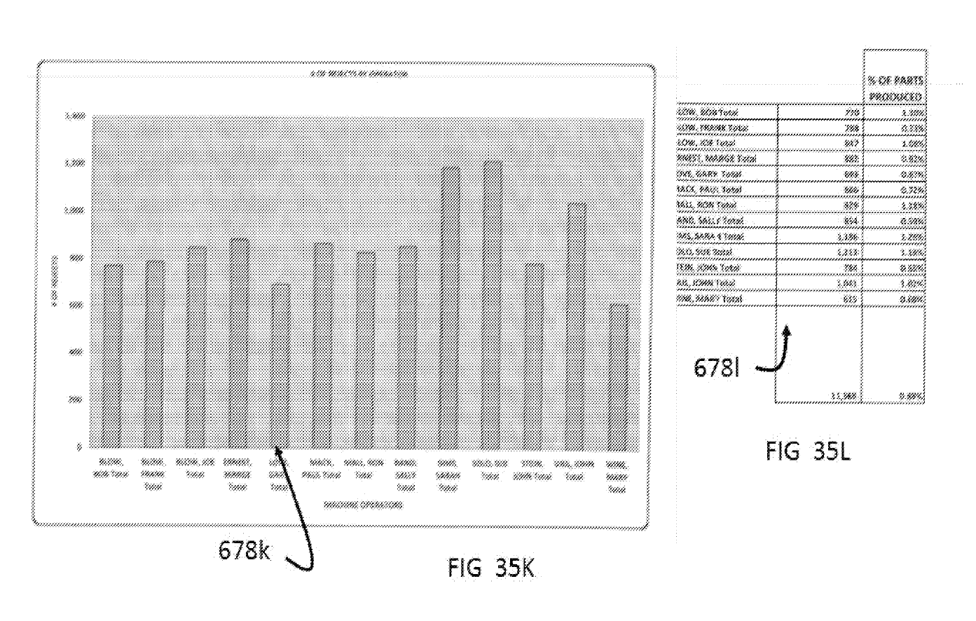

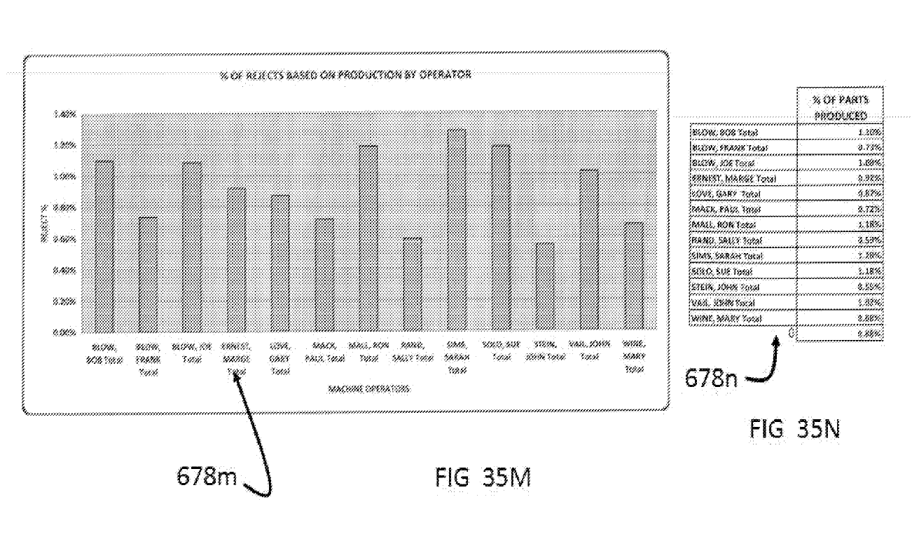

The More Charts cell 678 may link to a further menu of charts, not shown, or to a worksheet having a variety of additional charts such as charts\graphs 678a through 678l, shown in FIGS. 35A through 35N, respectively.

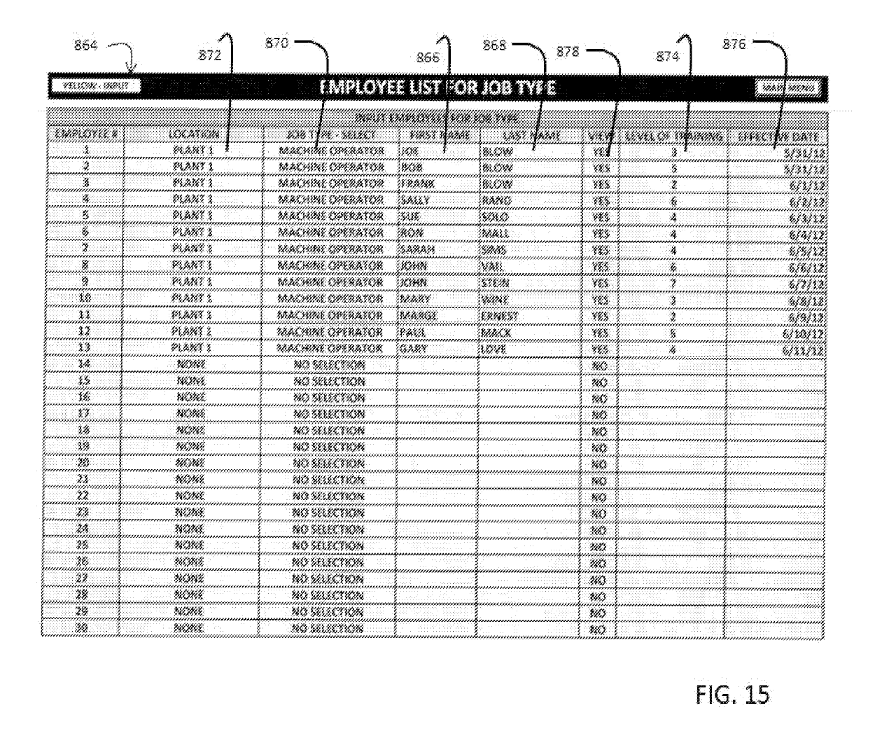

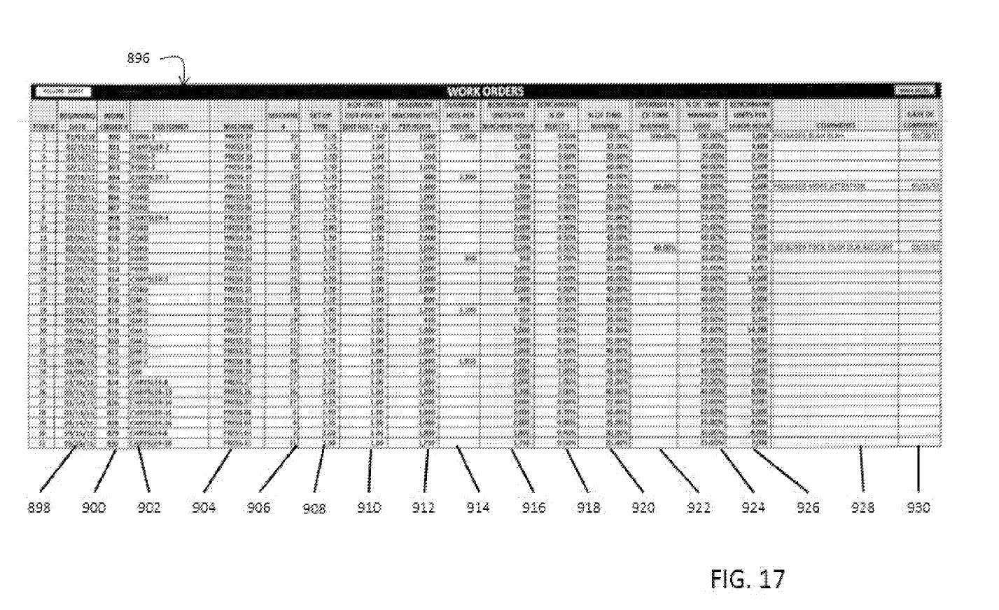

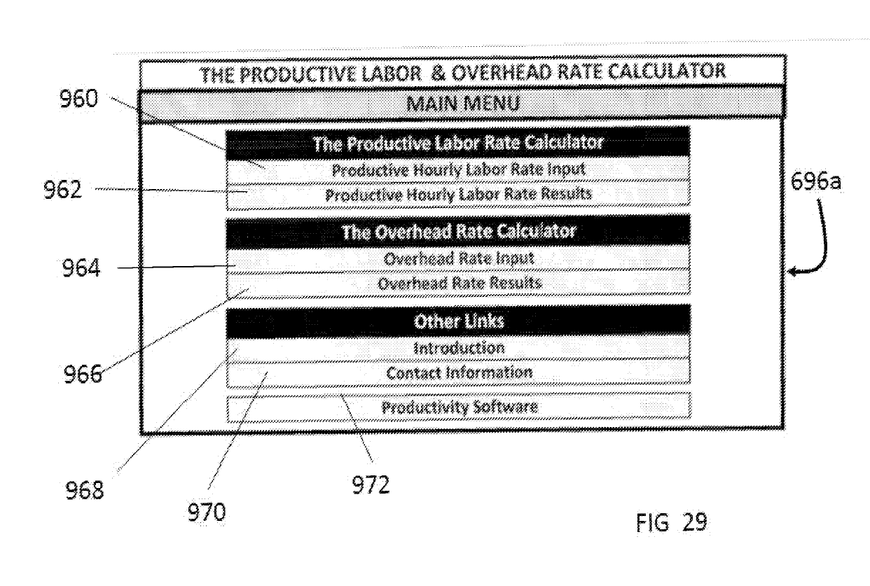

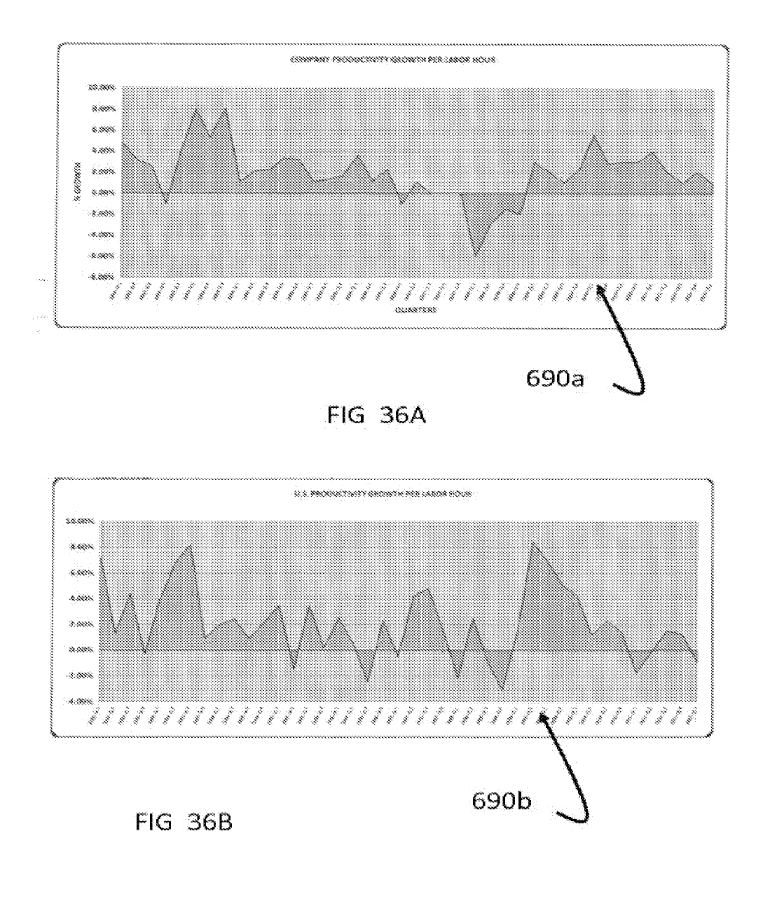

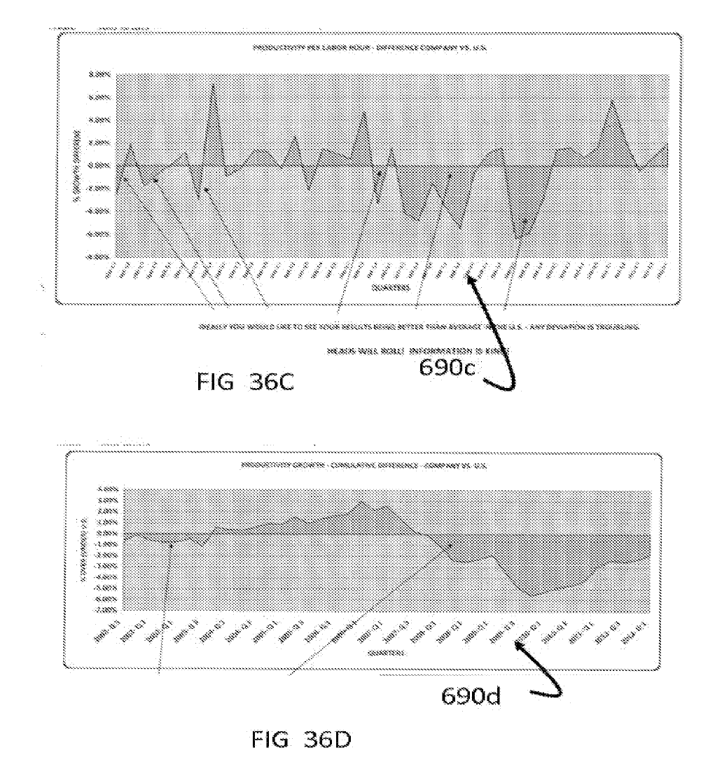

Main Menu 650 also includes links 682 to other useful locations in the workspace, such as the Setup Utilities 684 linking to Setup Menu 700 on FIG. 12, Employee List 686, linking to chart 864 on FIG. 15, Work Order List 688 linking to 896 of FIG. 17, Labor Productivity Growth—Company vs., US 690 linking to graphs 690a through 690g on FIGS. 36A through 36D, respectively, Introduction 692, linking to an introduction to the software, not shown, Contact Information 694, linking to contact information about the software provider or the IT support function of the enterprise, not shown, Labor and Overhead Rate Calculator 696 linking to menu 696a on FIG. 29, and Information Request 698. Each of these links 654 through 696 go to relevant portions of the workspace described below, at least some of which may reside on separate appropriately named worksheets to facilitate access. Additional graphic links, such as link 699 to the setup menu may be provided throughout the workspace.

As shown in FIGS. 11B and 11C, additional textual explanations and user help text may be provided throughout the workspace, such as definition of terms shown at 658a in FIG. 11B and explanation of measurements shown at 658b in FIG. 11C.

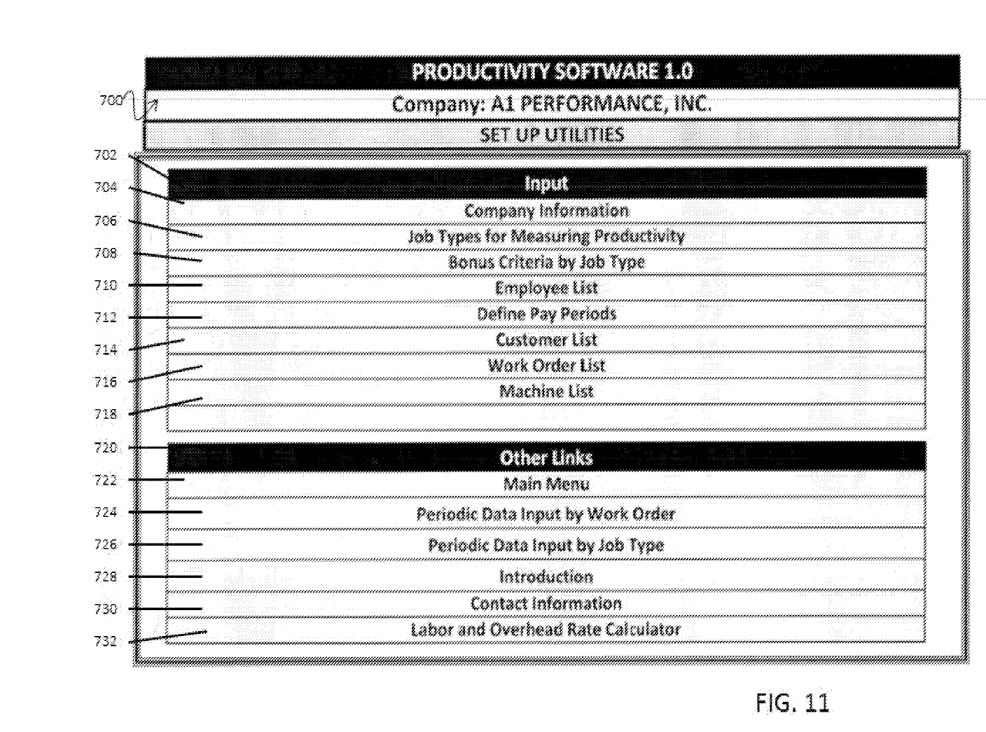

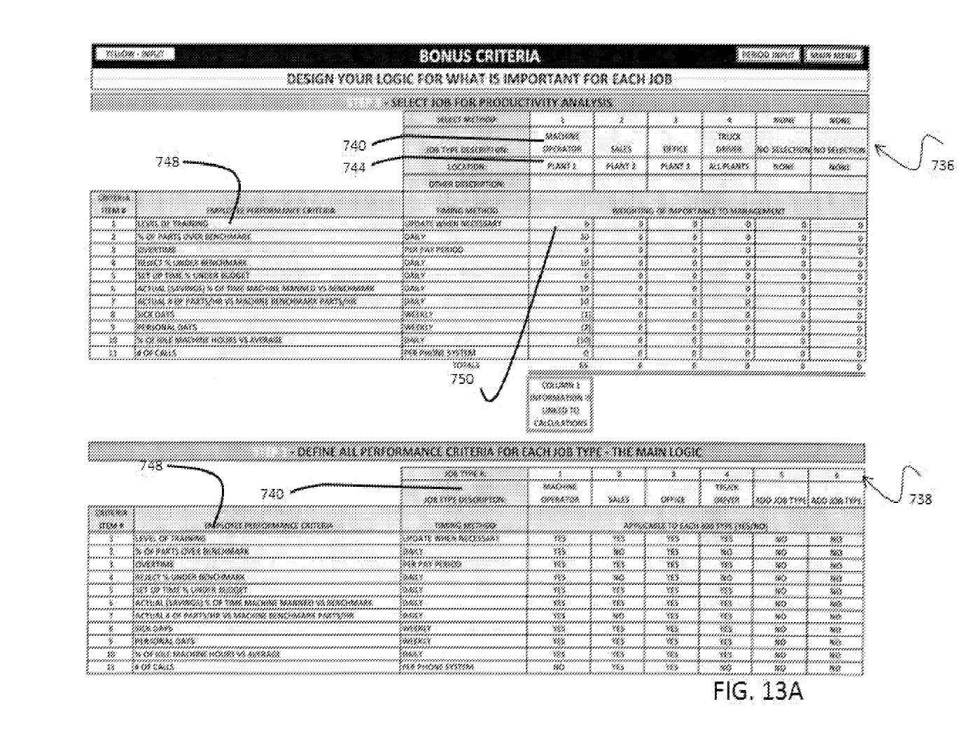

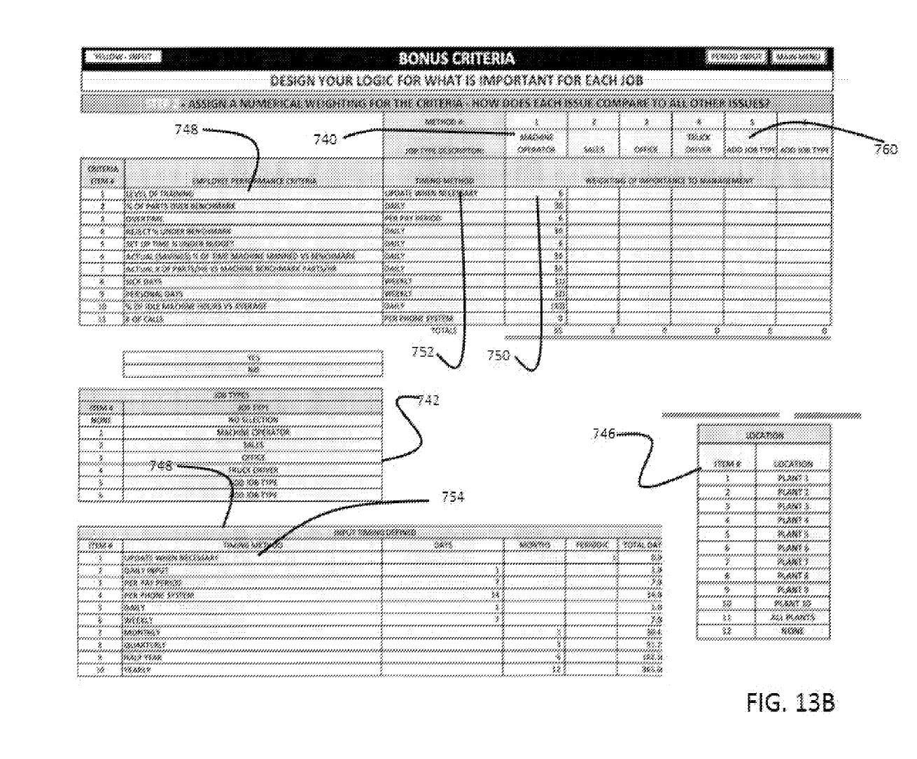

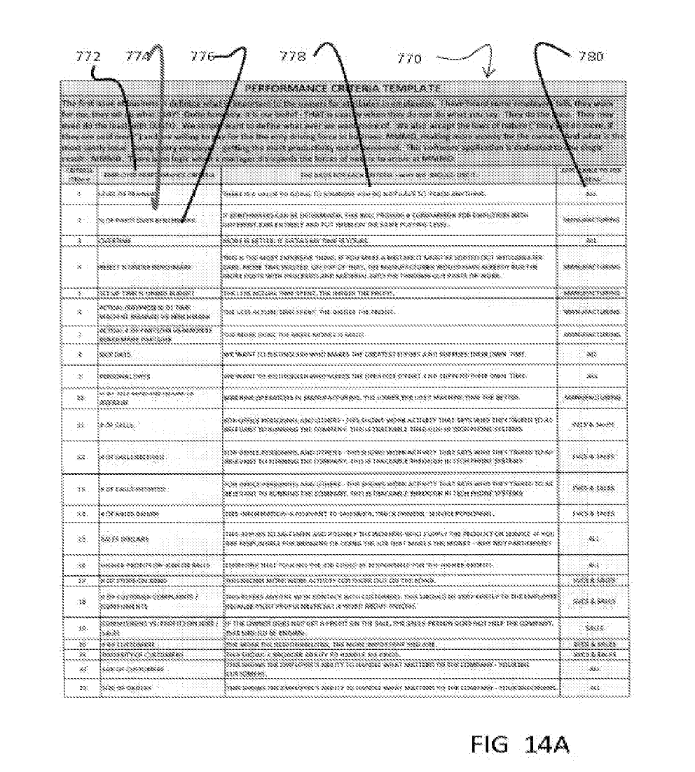

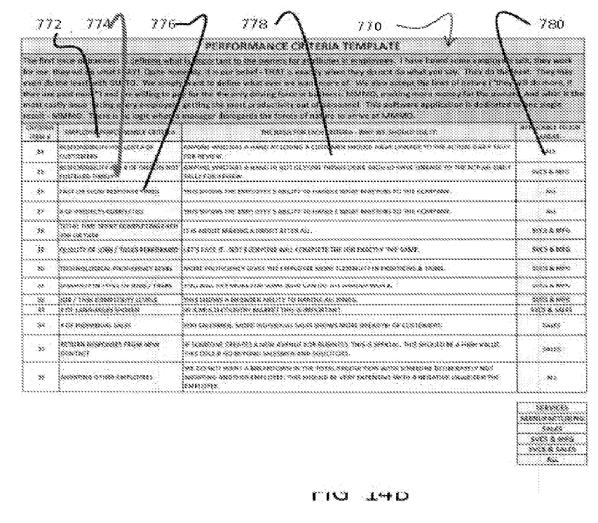

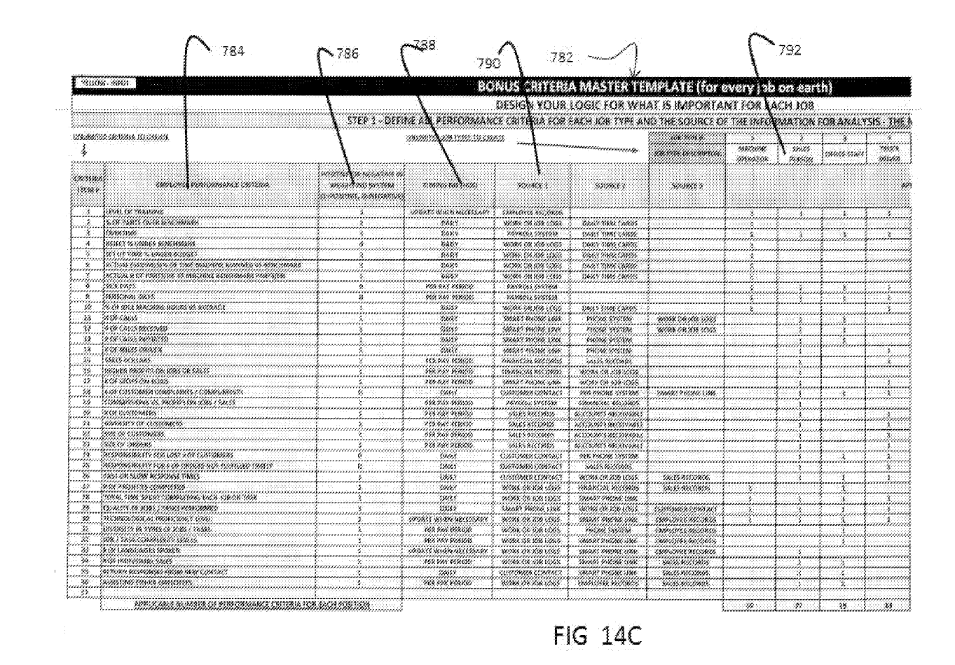

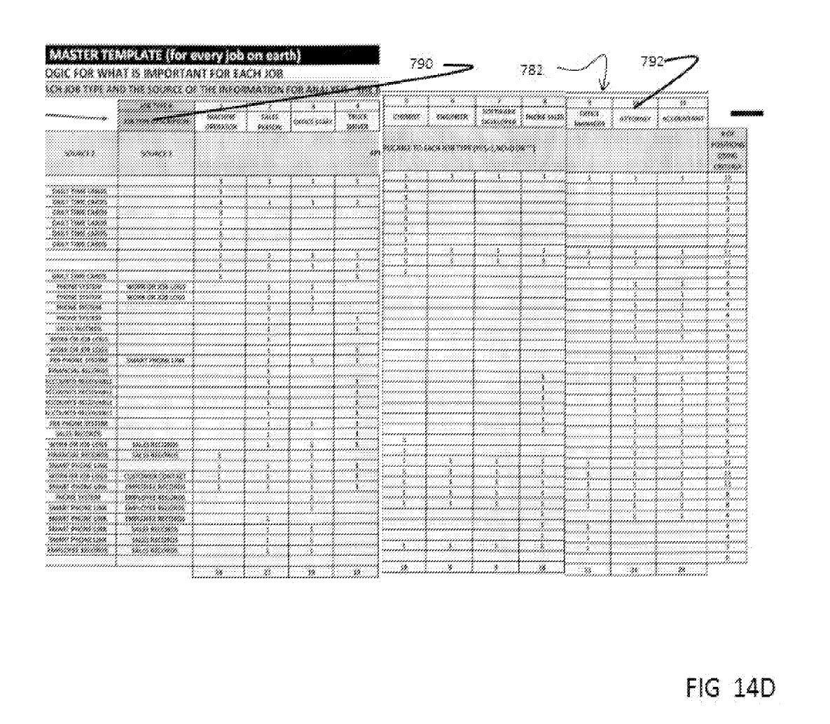

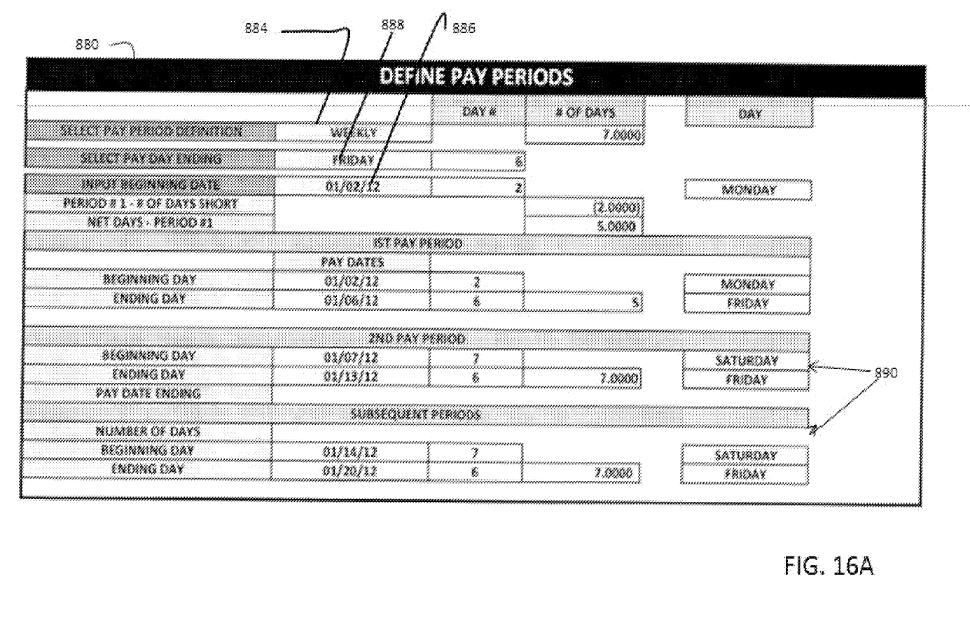

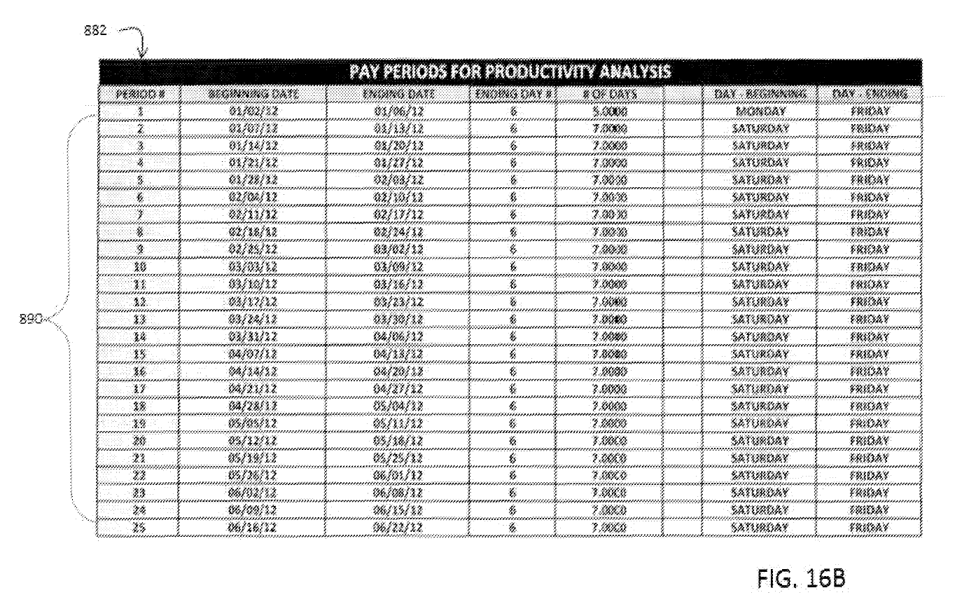

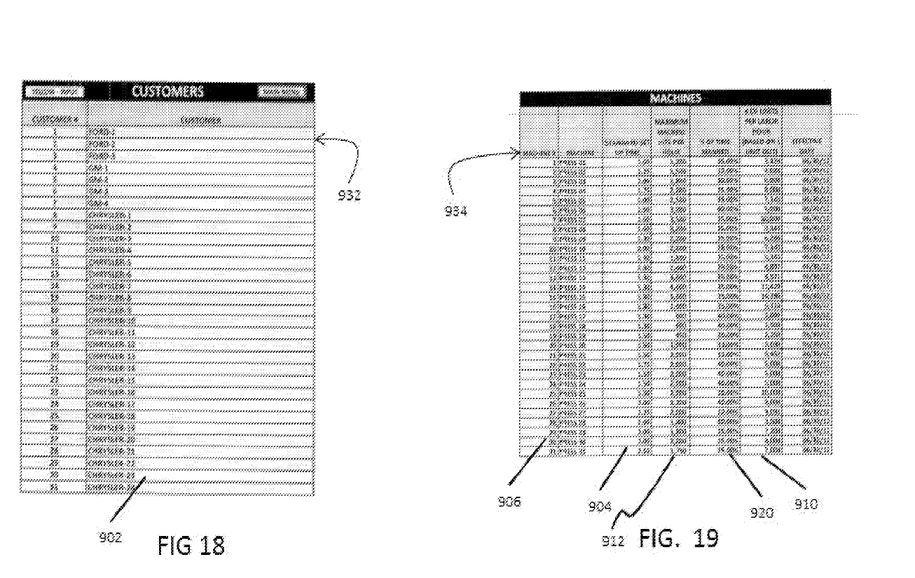

FIG. 12 depicts a set up menu 700 for initiation use of the productivity system. Menu 700 can be accessed, for example, by selecting Setup Utilities 684 or hyperlink button 699 on Main Menu 650 or by selecting a worksheet named Setup. The menu allows selection of categories for input 702 which link to appropriate forms such as Company Information 704, Job Types to Measure 706, Bonus Criteria 708 linking to charts 736 and 738 on FIGS. 13A and 13B, the Employee List 710 detailing information about the employees including their job type, linking to chart 864 on FIG. 14, Defining Pay Periods 712 over which the performance will be measured and at the end of which timely bonuses may be awarded, linking to charts 880 and 882 on FIGS. 16A and 16B, respectively, Customer List 714 linking to chart 932 on FIG. 18, Work Order list 716 linking to chart 896 on FIG. 17 defining each pending job/project and indicating which employees/departments are accountable for performance, Machine List 718 defining activities, cycle times or task duration relevant to specific tasks and employees linking to chart 934 on FIG. 19. Selection of any of these choices will link the user to an input form for entering the relevant information.

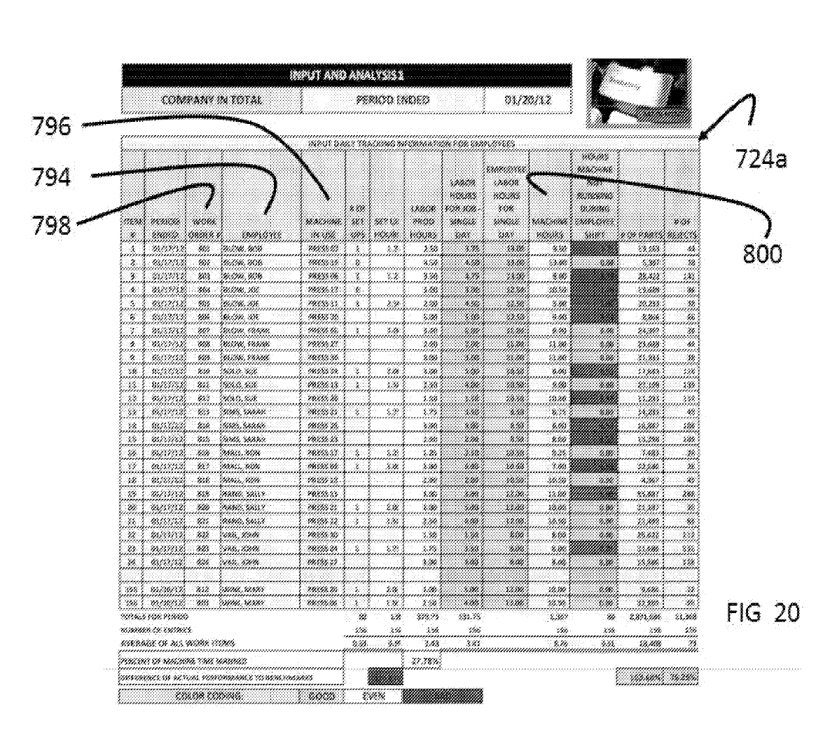

Setup Menu 700 also includes links 720 to other useful locations in the workspace, such as the Main Menu 722, Work Order Input 724, linking to chart 724a on FIG. 20, Job Type Input 726, Introduction 728, Contact Information 730 and the Labor and Overhead Rate Calculator 732. Many of these links go to relevant portions of the workspace referenced above relative to the main menu and described below in greater detail, at least some of which may reside on separate appropriately named worksheets to facilitate access.

FIGS. 13A and 13B depict the Bonus Criteria screens 736 and 738 permitting selection of applicable performance criteria and weights by job assignment, which may be accessed, for example, by selecting the Bonus Criteria category 708 on Input menu 702. The Bonus Criteria information shown in FIGS. 13A and 13B may be provided on a worksheet with an appropriate name, such as Bonus or Bonus Criteria or Setup and may be accessed by appropriate links, such as link 708 on Setup menu 700.

The user may select from a drop down menu a job name at 740, such as machine operator, The job names available are shown at 742 in FIG. 13B and may be modified or supplemented at any time by an authorized user. The jobs name list may reside as shown on the same worksheet with the Bonus Criteria or on a separate worksheet having additional information about each job or elsewhere in the enterprise data system. The user may select a location for the selected job from a drop down menu (not shown) or other resource at 744 in FIG. 13A. The available locations table, shown at 746 in FIG. 13B, may be modified and supplemented by an authorized user and resides in an appropriate location within the workspace or elsewhere in the enterprise data system. Additional descriptive categories beyond job and location, such as department, division, job subcategory, may be added below 746 by adding lines to the spread sheet as needed or desired for more refined analysis, bonus calculation, or reporting.

Next, the user may select applicable performance criteria from a list of proposed criteria at 748, such as level of training, and then enter a weight for each selected criteria at 750. An authorized user may add to the list of criteria as needed from a master list of performance criteria, not shown in FIGS. 13A and 13B, residing elsewhere in the workspace or the enterprise data system. The list of potential performance criteria may be modified as will be described later herein.

Next, as shown in FIG. 13B, the user selects a timing category at 752 for the job and performance criteria from a drop down list of potential timing alternatives, shown at 758. The timing alternatives specify the frequency of input into the performance system of a number quantifying the performance criteria, such as daily, weekly, hourly, per event (such a phone calls or consumer email) or when necessary. It will be appreciated that setting of other characteristics of the performance criteria may be incorporated into the performance system, such as source of performance criteria measurement or the method of calculation of the performance criteria. Examples of sources include data already on another existing database, data entered periodically by a specific grader, or a measurement taken from a tool. Examples of method of calculation include moving averages, maximum values, and long term values taken over multiple bonus periods.

The user may then repeat this process adding additional performance criteria for the job, then adding more jobs, such as sales, office, or truck driver, by selecting “add job type” as shown at 760, which will create a new column, as shown at 762, corresponding to the added job.

Referring to FIGS. 14A through 14D, it will be appreciated that the list of performance criteria provided at 748 in FIG. 13A may be drawn from a more detailed listing of performance criteria. As shown in FIGS. 14A and 14B, a master list of performance criteria may be provided in a template 770 listing potential performance criteria 772 such as level of training 774 and number of parts over benchmark 776, a descriptive basis 778 for each potential performance criteria, and a list of suggested jobs 780 for which the performance criteria may be appropriate. Performance Criteria in template 770 may be associated with a more detailed template 782 shown in FIGS. 14C and 14D providing more detailed information about each measure, including the name of the performance criteria 784, whether the criteria is positive or negative in the performance appraisal at 786, the timing method 788 associated with the criteria, the potential sources 790 of data from which the performance criteria may be derived, and the jobs 792 associated with the criteria. It will be appreciated that the data in template 782 is linked to the data in Bonus Criteria screens 736 and 738.

Performance criteria 784 in template 782 may also be associated with a method of calculation, if the number defining the criteria is not merely a directly measured, harvested of entered number.

FIG. 15 depicts a screen showing an employee list by job type 864 wherein specific employees are associated with the job types referred to in FIGS. 13A and 13B. The user may enter each employee name in columns 866 and 868 manually or by first selecting a name from an employee list, not shown, provided by human resources department or linked to an existing database with employee information. The user then selects a job title at column 870 and a location at 872 from the respective drop down lists described above, as well as any other desired criteria that may be added to this form as need, for each employee. The level training of each employee, as well as the latest effective date of the training, and other relevant criteria may be entered manually or pulled from an existing database, in columns 874 and 876. An additional column, 878, may be provided for a link to view additional information about the employee, such as pay rate, performance history and performance scores.

FIGS. 16A and 16B depict portions 880 and 882, respectively, of a spread sheet showing pay periods applicable to the enterprise using the performance system which may be accessed, for example, by the Define Pay Period link 812 of the Setup Menu 700. It will be appreciated that there could be distinct pay period data for specific locations, departments, or work groups taking into account different pay period lengths, different shut downs or layoffs, and different holidays. Furthermore, a different pay period data set may be provided for contract employees taking the term of their contract into account. A pay period data set is created by selecting at 884 a duration, such as weekly, monthly, bi-weekly or semi-monthly. A starting date and a payday for the first pay period may be entered, respectively, at 886 and 888. Subsequent start and end periods of pay periods are automatically generated, as shown at 886 for the second pay period and 888 for the third pay period, or as generally shown in chart 890 of FIG. 15B. An authorized user may override any calculated start and end period to account for layoffs, holidays and other events. Furthermore, the start and end dates may be alternatively pulled from human resource software, such as payroll software.

FIG. 17 depicts an exemplary work order chart 896 listing data for each work order which data may be used to determine productivity. These include data representing the expected or benchmark performance of machines and people involved in completing the work order and may be included in the information used by a sales person in estimating the cost of completing the work order. It will be appreciated that, for some enterprises, this part of the productivity system does not involve a work order, but instead may be effectively used to track projects, subprocesses, or tasks that involve multiple participants, in which event the column headings will be created to correspond to data categories of importance to that enterprise and that project or process.

The exemplary work order chart 896 includes start date 898, work order or job number 900, a customer name or number 902, machine name 904, machine number 906, set up time for the machine 908, number of units out per hit 910, maximum machine hits per hour 912, override hits per hour 914, benchmark units out per machine hour 916, benchmark % of rejects 918, % of time machine is manned 920, override % of time manned 922, % of time manned used 924, and benchmark units per labor hour 926. It will be appreciated that a work orders may correspond to more than one machine and therefor may require more than one line in work chart 896. Various entries in the work order chart 896 are derived from drop down lists pulled from other charts, such as the customer name 902 being pulled from customer list 932 of FIG. 18. Machine information for columns 904 through 918 may be pulled from a machine benchmark characteristic chart 934 shown in FIG. 19. It will be appreciated that the benchmark data in machine chart 934 may not only be used to gauge performance of employees using these machines but may be used to evaluate need for servicing the machines. The benchmarks may be periodically revised based on the average performance measures so as to reflect a new benchmark reflecting machine performance in the enterprise's actual environment. Furthermore, it will be appreciated that the benchmarks may be unrealistic where a job is more complex, a part is heavier, or the operation in any other way should be expected to take longer than a typical operation. Chart 896 therefore provides an opportunity for a user to override the benchmarked data to set a more reasonable target.

Ultimately, one or more performance criteria numbers for one or more employees may be generated from comparing data harvested during the performance of the work order for comparison with the benchmarks and overrides of chart 896. Comments and the date of comment related to the project may be entered in columns 928 and 930 respectively. Work order numbers may manually entered or populated, if desired, from a contract tracking database, not shown.

The customer list 892 of FIG. 18 may be manually entered or pulled from an existing data base such as an accounts receivable or a contacts management software system, not shown. A user may have access to more information about any customer by clicking on the name of the customer. Customer list 892 may be accessed as a drop down list for populating still other portions of the performance system.

Referring now to FIG. 20 illustrating a work order input chart 724a, which may be used more generally as a client, project or process input chart for the exemplary enterprise. In particular, chart 724a associates employees 794 with tasks, in this example tied to machines 796, related to work orders, clients, projects or processes 798 for which each employee has accountability. One or more columns 800 are provided corresponding to each performance criteria associated with the employee, in this example criteria associated with the machines used by the employee. Cells in chart 724a and those which follow in this description may be populated using drop downs or pulling data from other charts or sources in a manner similar to those described. Columns 800 capture the actual measured raw results needed for calculating the performance criteria, which can be compared elsewhere within the performance system with the target or benchmark set for each criteria.

Refer now to FIG. 21, depicting the Performance Input and Quick Results Chart 670a, illustrating the calculated performance criteria 802 for each employee 804. Performance Criteria 802 are calculated according to the instructions or algorithm chosen previously by the user. In the example illustrated, the performance criteria 804 are derived by dividing the raw data 800 from chart 724a by the benchmarks or overrides set in chart 896 for the same performance criteria. In addition, columns are provided for other performance criteria drawn from other sources, in some cases reflecting objective and subjective measures. For example, columns are provided for inputting measures of sick days 806, personal days 808, and level of training 810 which may be retrieved from enterprise HR data. Also, as an example, a performance criteria of number of calls 812 is provided as an example of data that may automatically retrieved from a tool, in this case a phone system database.

A column 816 contains formula for calculating each employee's productivity score. A column 818 repeats the productivity score for those employees whose score or other considerations qualify them for participation in the bonus pool, which is used to calculate a prorated participation of each employee in the bonus pool shown in column 820 and the bonus amount shown in column 822. An alternate performance score, such as productivity percentage 824 or price per productive unit 826, may be provided in another column and calculated from the performance criteria and other data according to another preprogrammed algorithm to provide other information of use to management related to employee performance. Cells may be color coded to draw attention to exceptionally high and low measures and scores.

The calculated numbers in chart 670a may be calculated directly by formula in the respective cells or may, as shown in FIGS. 22a and 22B be calculated in a Bonus Calculation Chart 662a calculating the independent contributions 828 of each performance criteria, such as level of training 830, to the productivity score 832 of each employee 834. For purposes of illustration only three performance criteria are shown in the FIG. 22A. Bonus Calculation chart may also be used to calculate alternative performance scores 836 and bonus 838. Use of a Bonus Calculation chart is particularly advantageous if any adjustments, non-linear calculations or other steps are required beyond merely summing the products of the weights and performance criteria.

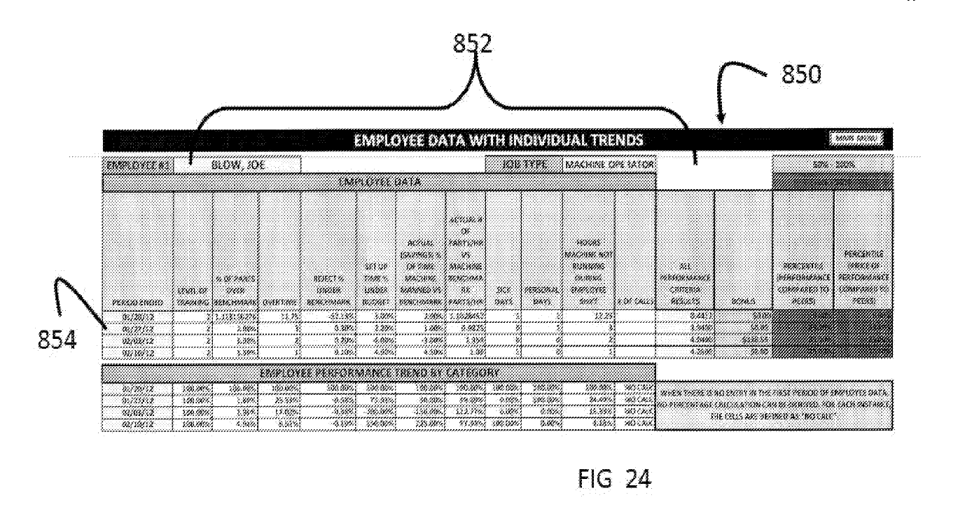

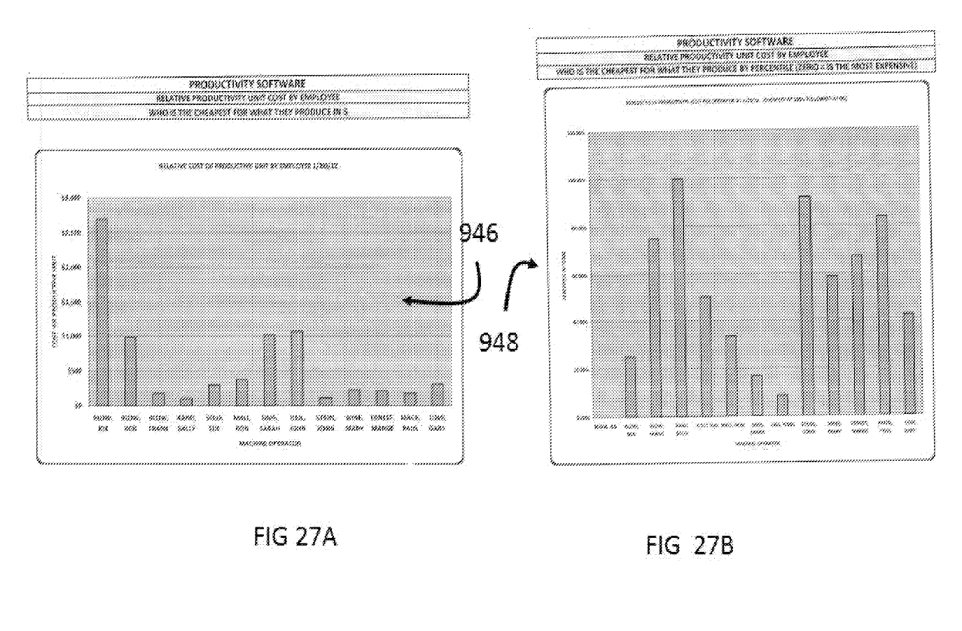

Various additional charts or reports may be provided to communicate information gathered by the performance system. FIG. 23 depicts an Employee Performance by Period Chart 666a providing a snap shot of the raw data 840 and calculated data 842 over a range of appraisal and bonus periods 844 by employee 846. FIG. 24 depicts an Employee Data Trend Report providing a more detailed breakdown of trends in individual measures 852 over several periods 854. FIGS. 25A and 25B depict an Employee Cost Chart 672a calculating and displaying the cost of the employee's compensation and overhead as applied to the work performed. More particularly, the cost of each employee 936 is divided by each employee's Productivity Units 938, calculated from the employee's performance criteria, to calculate a cost per productivity unit 940 that may be compared with other employees. A percentile cost comparison 942 (where 100% is worst performance) or 944 (where 100% is best performance) is also provided. FIGS. 26A and 26B depict graphs 674a and 676a graphically presenting percentile data 942 and 944, respectively, from Chat 672a. FIGS. 27A and 27B depicts graphs 946 and 948 graphically presenting a comparison of cost and of productivity units, respectively, by employee for a chosen period of time derived from the data of chart 672a. FIG. 28 depicts a graph 950 displaying a trend line 952 for each employee over several appraisal and bonus periods 954 derived from the data of chart 672a.

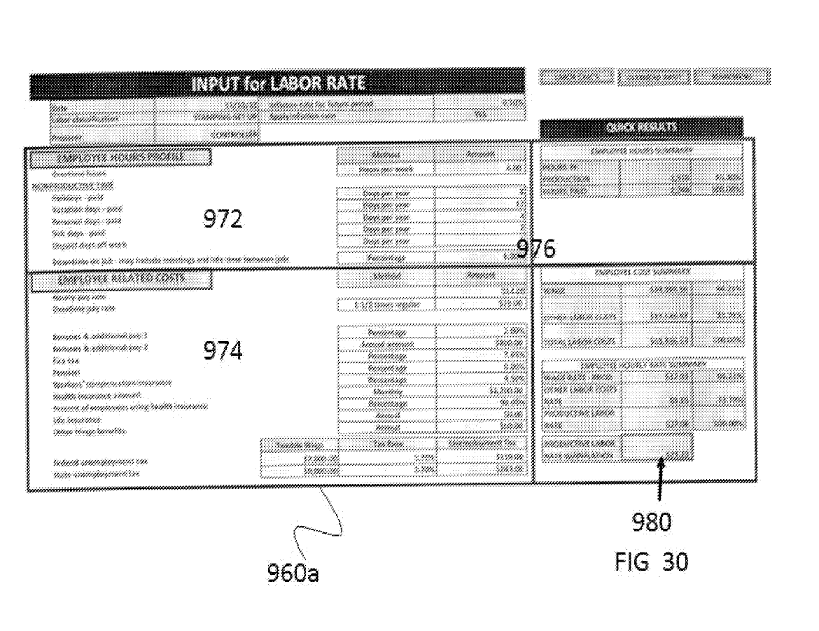

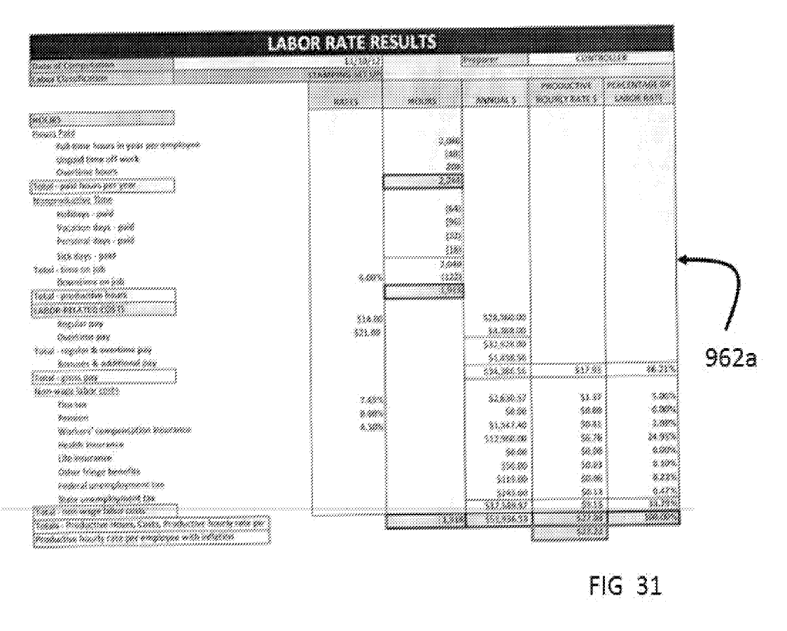

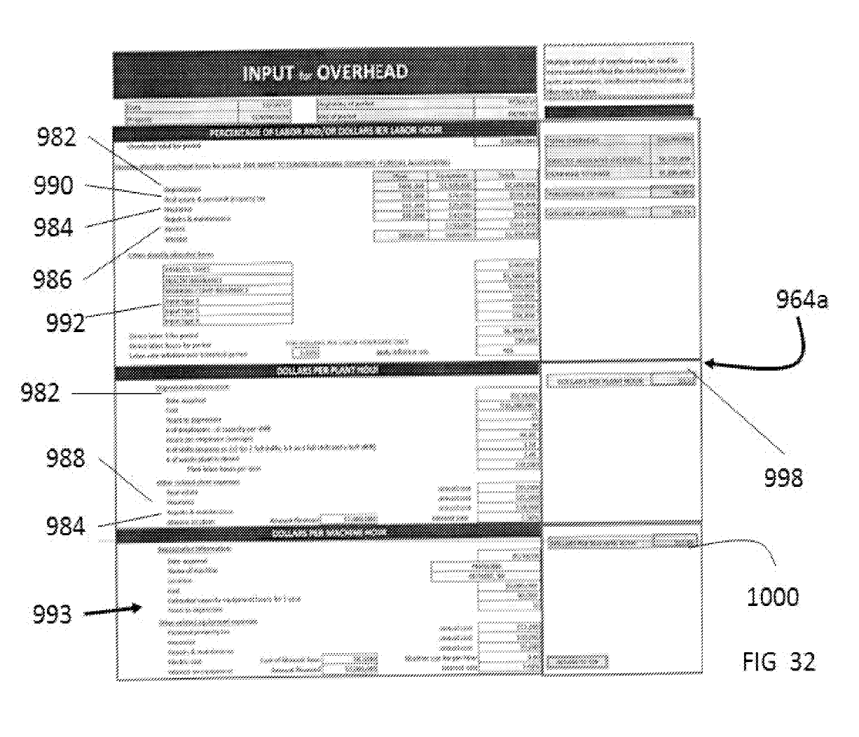

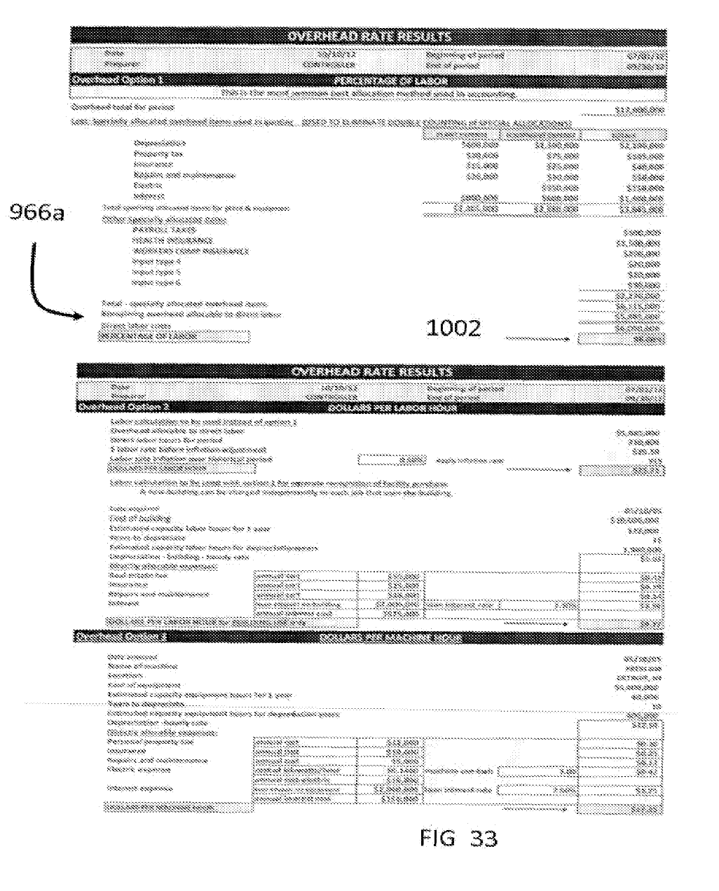

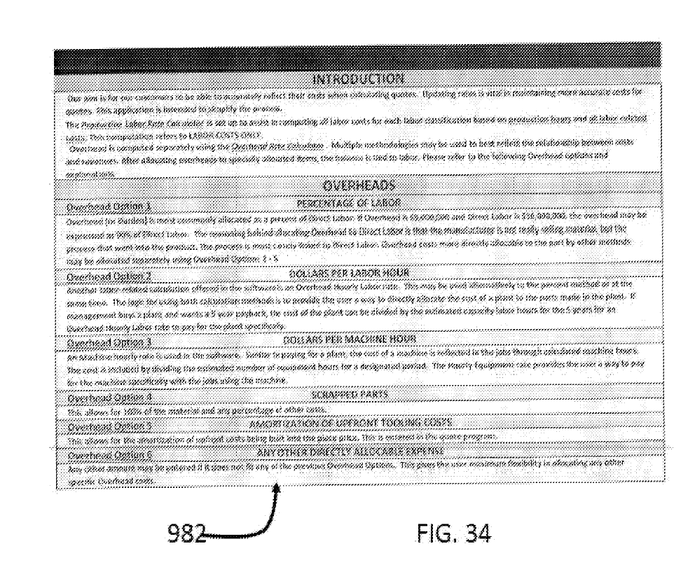

Refer now to FIGS. 29 through 34 generally depicting a Productive Labor and Overhead Rate Calculator for use as art of a productivity system described above. The exemplary calculator resides on appropriate worksheets in the same EXCEL workspace as the other components described above. Alternatively, especially for large enterprises with large numbers of employees, the calculator resides on appropriate dedicated or dispersed software and hardware used by the enterprise. FIG. 29 depicts a Productive Labor & Overhead Rate Calculator menu 696a for navigating the Productive Labor and Overhead Rate Calculator, including numerous links to general information, input charts and output reports. The links may include Productive Hourly Labor Rate Input 960, linking to Labor Rate Input Chart 960a shown on FIG. 30, Productive Hourly Labor Rate Results 962 linking to Labor Rate Results Chart 962a on FIG. 31, Overhead Rate Input 964, linking to Overhead Rate Input Chart 964a on FIG. 32, Overhead Rate Results 966, linking to Overhead Rate Results Chart 966a on FIG. 33, Introduction 968, linking to introductory materials 968a on FIG. 34, Contact Information 970 and Productivity Software 972 linking to the main menu 650.

Refer now to FIG. 30 wherein the Labor Rate Input Chart 960a provides, for a method to define the true direct cost of each employee. Chart 960a includes a listing of employee hours 972 over a specified period, such as a year. Chart 960a also includes a listing of employee related costs 974 including pay, bonuses, taxes, and benefits. This data may be entered by a user or pulled from enterprise HR data, broken down into categories such as holidays, vacation days, personal days, sick days, unpaid days off, and downtime. Chart 960a further includes a calculation 976 of the absolute and percentage of productive hours, a calculation 978 of the total direct costs of the employee and a calculation 980 of the effective hourly rate of the employee based on total cost divided by productive hours. Labor Rate Results Chart 962a FIG. 32 shows the intermediate calculation of entries in chart 960a.

Refer now to FIG. 32 wherein the Overhead Input Chart 964a provides, for a method to define the true overhead direct cost of each labor hour, plant hour and machine hour. Chart 964a includes a listing of plant related expenses over a specified period, such as a year, including depreciation 982, maintenance 984, utilities 986, insurance 988, taxes 990 and allocated benefits 992 entered by a user or harvested from enterprise data. Chart 960a also includes cost data at 993 connected with one or more machine. Chart 960a further includes a calculation of the dollar cost per plant labor hour 994, per plant productive hour 996 and per machine hour 1000. Overhead Rate Results Chart 996a of FIG. 33 depicts the calculation of the percentage relationship of labor costs to overhead costs, adjusted for tax and benefit expenses which are allocated to the plant.

FIG. 34 provides user guide and introductory definitional information 968a for the Productive Labor and Overhead Rate Calculator.

FIGS. 35A through 35L provide examples of reports in the form of charts and graphs that may be produced by the productivity system using the raw and calculated data described above.

FIGS. 35A and 35B, respectively, report in a graph 678a and a chart 678b dispositions by employee, such as the units produced by machine operators for a specified period of time. FIGS. 35C and 35D, respectively, report in a graph 678c and a chart 678d idle time, such as idle machine hours by employee. FIGS. 35E and 35F, respectively, report in a graph 678e and a chart 678f a process improvement, such as set up time saved as a percentage of benchmark by employee. FIGS. 35G and 35H, respectively, report in a graph 678g and a chart 678h another process improvement, such as run time saved over a benchmark by employee. FIGS. 35I and 35J, respectively, report in a graph 678i and a chart 678j output rate, such as number of parts produced by labor hour by employee. FIGS. 35K and 35L, respectively, report in a graph 678k and a chart 678l a quality issue, such number of rejects produced over a bonus period by employee. FIGS. 35M and 35N, respectively, report in a graph 678l and a chart 678n another perspective on the quality issue reported in a graph 678k and a chart 678l, by examining the percentage of rejects over a bonus period by employee.

FIGS. 36A through 36D provide examples of graphical reports that may be produced by the productivity system using the raw and calculated data described above as well as information harvested from internal and external databases or shared between enterprises.

FIG. 36A depicts management's productivity in a graph 690a plotting enterprise wide productivity growth, as compiled by the productivity system per labor hour over an extended time period. FIG. 36B depicts an external report of productivity in a graph 690b plotting US productivity growth per labor hour, from data provided by government sources. Similar graphs may be created for industries, other countries, job categories, specific competitors from various sources of external data. FIG. 36C compares management's productivity with an external benchmark in a graph 690c plotting enterprise wide minus US productivity growth per labor hour an extended time period. FIG. 36D compares management's cumulative productivity improvement with an external benchmark in a graph 690d plotting enterprise wide minus US cumulative productivity growth per labor hour an extended time period.

Other reports, charts and graphs may be generated as such as comparing Productivity Criteria or Productivity Scores with other companies or various departments with each other. Bonus Pools may be established to provide an incentive for process or quality improvement between teams of employees. Another category of data mining may be analyzing productivity by customer to determine if certain customer's projects are, in practice, less efficient and therefore require either an adjustment in estimating costs or a modification in the manner of dealing with the customer. Data from the productivity system may be used as input in plant closing and remodeling decisions as well as pinpointing facilities and teams that may have previously unrecognized best practices or bad practices.

Thus, when implemented, the performance appraisal rewards system 112, using one or more of processes 200, 250, 300, 350, 400 and 500 or the Excel workspace of FIGS. 11 through 34 uses both input capture devices for capturing performance data for each of said plurality of workers during a tabulation period, whereby management of said organization determines key performance criteria for each said worker and data entry devices enabling each worker to enter work-related data during said tabulation period. The system assesses and tracks operational and functional performance for the purpose of rewarding those workers that provide the most value to the organization. Initially, management decides what is important in a particular job along with the best way to track performance. Each defined performance criteria is then assigned a numerical weighting by management. Those performance criteria items with higher weightings are assigned a greater value. The sum of all the disparate criteria items equals the performance of that worker and is assigned a numerical value for that time period, preferably a pay period, against all other workers performing the same type of job. Then, the performance of each worker is reviewed for purposes of determining whether or not to pay said worker a reward for that pay period.

It will be appreciated that, when management confronts workers with performance appraisals, the issues may be complex and subject to misunderstanding. The productivity appraisal and rewards systems described herein automate the tracking of worker performance and may minimize surprises in face-to-face performance appraisals, and may reduce the frequency holding meetings solely for that purpose. Each individual worker knows what is expected and how he or she is performing at all times by monitoring performance activity on a computer screen within the organization.

If desired by the organization, the productivity systems disclosed herein allocates a reward amount to be paid for each pay period based on performance. Management decides the reward amount to be paid, and the productivity systems disclosed herein allocates the money to the workers who are performing at the highest levels. Management can exclude a bottom percentage of workers who did not do enough and do not earn a reward for that pay period. For example, management may decide to exclude the bottom 40% from the reward pool. The rewards are designed to create better performance. The rewards are not effective if they do not add more value. If each worker can see his or her own performance percentile, the worker will have an extra incentive of getting over the top, improving from the week before, or staying out of the bottom. The heavier allocation to the best doers promotes the concept of the organization, making the organization profitable by performing the tasks assigned to that particular worker effectively and efficiently. The performance average will rise with every paycheck because each worker is competing to beat the others out of the bigger slice of the pie. This effectively introduces capitalism into the individual workplace.

The question arises, would the productivity systems disclosed herein generate a non-cooperative work environment that results in cut-throat competition that results in a reduction in productivity within the organization? In short, the answer is no. One of the tasks of each co-worker is to assist a co-worker when so asked. The performance tracking items will give very low marks to any worker who does not help a co-worker. If there is no tension in the workplace, nothing gets done either.

Initially, management decides what is important in a particular job along with the best way to track performance. Each defined performance criteria is then assigned a numerical weighting by management. Those performance criteria items with higher weightings are assigned a greater value. The sum of all the disparate criteria items equals the performance of that worker and is assigned a numerical value for that time period, preferably a pay period, against all other workers performing the same type of job. Then, the performance of each worker is reviewed for purposes of determining whether or not to pay said worker a reward for that pay period.

Now, how hard is it to know who made you more money: Is 5 bigger than 2? Or, in an alternative embodiment of the productivity systems disclosed herein, all the workers and relative items appear in different colors shades based on what group they fall in: Productive workers are defined as doing more than the average. Therefore color those in green, the average workers another color, and the non-doers, based on the facts, are obviously red. The analysis also shows all the workers for each group in chart form. The user will see the ups and downs of everyone's productivity by each period and the order of each worker based on the reason most get a paycheck: performance. All performance factors are updated each pay period. The performance items will be tracked automatically wherever possible through linkage with other devices and programs.

In addition, all the workers are compared on a percentile basis. Being in the zero percentile does not mean that the worker person did not do anything, but rather it means that based upon management's priorities and weighing system of what is important in this job, that the worker did the least. Conversely, being in the 100 percentile means that the worker performed at the highest level, or did the most. Now management knows exactly who did what and in what order without ever leaving a computer monitor. This knowledge is powerful. Now management can allocate all resources to profitability centers—those workers that meet or exceed expectations. No more wrongful termination suits due to reasonable cause. It is always a reasonable cause for management to expect productivity from its workers. Documentation makes this issue less likely. The less exact previous methodology requires many conversations with the most expensive management personnel to decide if it is safe to terminate someone. The accumulation of time waiting compounds the cost of keeping a nonperforming worker. Both paying the worker for not performing paying for management to resolve the situation cost the organization money. Once again the productivity systems disclosed herein saves the organization money by resolving these situations in compliance with legal requirements and in a manner that is fair to the worker.

Another comparative process available in the application, allows management to match which worker is best at each task to optimize productivity and cost for each function. It can be seen that this area will expand to many areas. Each worker will be sorted by each job or task by performance percentile and cheapest cost performance percentile. In other words, the productivity systems disclosed herein seeks out the best way to make each worker the most productive.

Here is a simplified example to illustrate the point. You have Worker A and Worker B. Worker A does the job at a cost of $2,000 per pay period. Worker B does the job at a cost of $1,000 per pay period and performs 80% as much as the Worker A. If the organization has two workers performing at the 80% level for $1,000 each, there is 60% more performance on the same money. The productivity systems disclosed herein tells management who to match the jobs with based upon the profile of performance and cost.

Management can identify the doers and reward them to keep them motivated to perform at a high level. Of course, the bonuses are allocated based on percentile of performance (productivity).

The weighting system is developed when management defines values for each attribute. Only the performance criteria that apply are used for each job type. The bigger the number, the more important is the attribute to management for the specific job. If no one “earns” one of the performance criteria, then it is not calculated in the result of the individual worker's performance.

The job areas listed on the previous schedule are general classifications. When setting up the productive analysis models, each job type within the organization has its own set of attributes and weighting values to base the logic. This is the decision of management to establish the right values of what is important to them in every specific job type.

Within every weighting system there can be both positive and negative values. Negative values are minimized so that overall costs are not divided by a negative number, thereby yielding a negative product. The negative calculation method is used sparingly so the productive unit amounts earned remains positive for all workers. Each worker that is being graded by the productivity assessment rewards system disclosed herein is listed in the order of his or her comparative numerical grade for every grading period. Everything comes back to where everyone falls in the percentile which does not change even if the productivity values may be negative for a worker. This raises the question, why use negative numbers at all if it means that the productive unit cost may be skewed? Our reasoning is that this more closely approximates how the marketplace would characterize a negative attribute—subtract it from the worker's overall value to the owner. To many analysts it would be more accurate to say the worker earned less productive units because of losing a customer or anything else big for that matter. It more accurately reflects the situation to show it as negative. It just makes the worker's value less than it is before the incident. The positive way to show the same thing is to give everyone else a value for not being prominent in this attribute, while the participant will get a zero. Since all the analysis is based on percentiles, the overall pecking order based on performance is preserved in both methods.

Since each worker knows exactly what is expected of him or her, the productivity assessment rewards system disclosed herein is inherently fair. Management will automatically be rewarding the doers, and the doers will feel appreciated with their fatter paychecks.

Then the task becomes one of gathering the relevant information most effectively.

The productivity systems disclosed herein integrates all the timing methods of the information needed to answer the performance criteria issues itemized above. The timing methodologies as necessary, hourly, per pay period, daily, weekly, bi-weekly, monthly, bi-monthly, quarterly, semi-annually, annually, or periodically or any combination of these.

Some of the links will be created to access and track worker information through such things as the organization phone system, driving logs, accounts receivable, per phone system, financial records, worker records, smart-phone links, daily time cards, payroll, sales records, work or job logs, customer contacts, machine operation.

Seamless linkage to all the information sources detailed herein will automate the productivity systems disclosed herein. Both management and the workers connect to their respective servers using whatever equipment and protocol they currently have access to, and the invention provides seamless linkage to all users within the organization.

Productivity measurement also extends to the following:

WORKERS. This is the single most important area to define where the productivity is linked—to the doers themselves. Who is the most efficient? Who is the most cost effective?

CUSTOMERS. Management will know the order of “who” gets the most productivity for their buck.

PLANTS. Management will know “where” you get the most productivity for your buck.

WORK ORDERS. Management will know “who” performs each job the best (and cheapest). You can link the right worker to each job for the most financial return.

TASK PROFILES. Management will know “who” of your workers does each task best (and cheapest) for the most financial return in each facet of a job.

SALES PEOPLE. Management will know “who” benefits from the most productivity from your buck.

LABOR PRODUCTIVITY GROWTH. Management will know if the organization productivity outperforms the U.S. average over time. Open goals will advance higher productivity within the organization.

ANY OTHER SORT INDEX IMPORTANT TO MANAGEMENT.

COMPARE DIFFERENT ORGANIZATION. Management will know which organizations have the best processes for investment purposes. The productivity systems disclosed herein is used by organizations for investment purposes to perform due diligences. Investment decisions will depend upon the likelihood of being able to turn an organization around or as an analysis tool for investors looking to penetrate a market.

The productivity systems disclosed herein is used as follows:
1) Performance tracking—the application tracks any performance important to management.
2) Timely bonus allocation per paycheck improves worker performance.
3) Making or saving money for management or improving the efficiency and effectiveness of the organization.
4) Hiring workers could change big. Organizations want to know if a prospective worker performs above average or below average and why. The percentile will be attached to the worker throughout his career. Obviously, the heat is on when you are tracked at every organization in the same fashion. The worker knows what is expected from the date of hire, and knows that performance is being monitored, and that worker compensation is based in part on worker performance. Again, the organization provides an incentive to its workers to produce and make the organization profitable. It becomes a very simple dynamic. Those workers that meet or exceed the expectations of management are rewarded each pay period.

A “productivity unit” is defined by the management of the organization in the responses as those tasks performed by the workers that are the most important to them. When the values of each criterion are defined, the valuation of a productivity unit is formed. For example, if there is a value of 30 for all the issues determining productivity, then that amount gets to be distributed to all the workers in the same job type by percentage of accomplishment. The sums of all the relevant individual performance results are added together to make up the performance number per worker. The number of productivity units each worker earns equals the value of the productivity units to the organization in that time period. The entire matrix is the sum of all the ideal wants in a worker. The end result coming out of the matrix point to who means what to the organization. Considering the multiple issues that need to be merged to form this analysis, it would be almost impossible to form the same conclusions by just being a “good manager.” The productivity systems disclosed herein will lead to the desired result: improved profitability. If a worker does not make more for doing more, then the worker will eventually do less.

Productivity Unit Cost—The productivity values are then converted into the actual cost of each productive unit earned based on the different costs (including indirect costs) of each worker. For example, Worker A may cost $500 per productive unit and Worker B may cost $300 per productive unit. Since the Productivity Unit term does not exist, the valuation, the Productivity Cost, thereof does not exist either.

Labor and Overhead Rate Calculator—In another preferred embodiment disclosed herein, the productivity systems includes a calculation methodology for costing out the direct and indirect labor costs to for each worker. This cost is then divided by the number of productive units the individual worker receives for the period. The cost for each worker's performance is tabulated. Dividing this number by the number of productivity units earned equals the cost of productivity unit by the individual worker.

The performance of any worker for any period is defined as a single number. Now, worker performance is absolutely defined for purposes of comparison. Looking at disparate issues and having an unfair way to compare them does not provide the analysis that is needed. Unfortunately, words cannot express what a number can. Each number has a value and is comparative by its value alone. This opens the door to providing rewards in a timely manner. Productivity is only one thing that matters.

Self-policing through an open performance information environment will reduce the need for a large mid-level management staff. Every worker will see only the results as it compares to everyone else. For instance, the worker sees on her monitor (by her workstation) that she is only performing at the 18% level in the pool for her job type, she will want to hustle and improve her performance score. If she were at the 40% percentile she would also want to improve her score to be eligible for the bonus. If a worker is performing at the 70% percentile and wants to improve his score to receive a larger reward the next pay period, it is much easier to attain what is well defined. The worker knows what needs to be done. The beneficial thing to the organization is that everyone else knows what to do as well. The level of productivity will rise from pay period to pay period because every worker is working to for a larger bonus.

This means management is effectively buying more and more productivity for a finite sum of money. This puts the productivity or benefit in reality, far ahead of the cost curve. The participants know this is the only game in town for greater rewards. The price point should be where there is a psychological impact on the worker participants to be all but animals in working harder to attain greater rewards. Management decides the price needed to reach the impact point. This is truly where your rocket scientists (management) should put their attention. It is known that too little is a waste because it does not do the job. Similarly, going overboard is a waste since the overboard amount costs more money. When deciding the proper price, it is still better to err on the side of going overboard in order to get the right productivity movement you would expect your money to produce. The extra issue is that once you offer a higher reward and then take it back by reducing the reward, you are running a high risk of making the worker participants feel disenfranchised from their new opening to the world of capitalism. It is not good to create a problem of losing the motivation of workers by them feeling like it can be taken away by the organization, or by management. No one wants to create a negative mentality in workers by cutting. Hence, the bonus set up should be given great consideration in the beginning. Management can always increase the amount of the incentive, while reducing an incentive is dangerous. This is the main take away: management wants its workers going to the maximum because of just enough incentive.

Any increased cost in information gathering with less expensive office workers will ultimately be automated and reduced as well.

Workers who perform well should be rewarded on a timely basis. If workers are not timely rewarded for positive performance, they tend to become complacent and learn to perform at a lower level. Sometimes there is a competition to do the least work. Management needs to avoid complacency and waste. We would prefer to create an environment that makes workers act like entrepreneurs. Workers can earn more money when they perform well and when the organization is profitable. Incentives promote higher performance by all workers. In comparison, it is believed that annual bonuses provide little significance in having workers perform continuously at a high level. The workers who are underachieving will be apparent as well. Incentive programs are most effectively applied with full knowledge of the entire workforce.

In another preferred embodiment of the productivity systems disclosed herein, workers are paired in teams of two or three based upon skillset, personality, and other factors. The paired workers learn from each other as they work together. Rather than rewarding each worker individually, the team is rewarded based upon the performance of the team. After several pay-periods, management re-examines the team composition and may or may not opt to assign the workers to another team.

In yet another preferred embodiment of the productivity systems disclosed herein, workers from all departments are rewarded for invention disclosures, suggestions, leads, and other new business opportunities that are of value to the organization. A worker may be a marginal performer at her assigned task, but if she is innovative, has good business contacts, has good business savvy, and adds value to the organization in any other way, said worker is valued, and such value is shared with the worker.

Also, some may look at the productivity assessment rewards system disclosed herein as intrusive, gathering information about each worker. It is believed that workers in every organization will not mind having this information being gathered if the end result is a timely cash reward for improved productivity.

The productivity assessment rewards system disclosed herein is designed to maximize the good and minimize the bad in workers in elevating overall productivity in the organization for the purpose of making the organization profitable.

Throughout this Application there are various Patents and Patent Applications referenced by number and inventor. The disclosures of these Patents/Applications in their entireties are hereby incorporated by reference into this specification in order to more fully describe the state-of-the-art.

It is evident that many alternatives, modifications, and variations of the productivity assessment rewards system disclosed herein will be apparent to those skilled in the art in light of the disclosure herein. It is intended that the metes and bounds disclosed herein be determined by the appended claims rather than by the language of the above specification, and that all such alternatives, modifications, and variations which form a conjointly cooperative equivalent are intended to be included within the spirit and scope of these claims.

In general with regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Features shown or described in association with one configuration may be added to or used alternatively in another configuration. The scope of the systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future configurations. In sum, it should be understood that the device is capable of modification and variation and is limited only by the following claims.

I claim:

1. A productivity system for evaluating a plurality of workers in an organization comprising:
at least one input capture device for capturing periodic performance data relating to each of a plurality of key performance criteria predetermined by management for each of said plurality of workers during a tabulation period;
at least one data storage device storing said periodic performance data, weights assigned by management to each of said key performance criteria and a productivity algorithm for processing said key performance criteria and said weights;
a computer for periodically performing said productivity algorithm to process said periodic performance data and said weights to determine a periodic composite numerical score for each of said plurality of workers, said periodic composite numerical score being reflective of management's appraisal of the relative value said worker added to said organization during said tabulation period; and
a computer for processing said periodic numerical score using a formula preset by management of said organization to calculate and assign a reward for any of said workers performing at a level deemed worthy of said rewards by management of said organization.

2. The productivity system of claim 1 wherein the input capture device captures at least one of measured data, user keyed in data, and updated data stored in an existing database.

3. The productivity system of claim 1 comprising at least two independent input capture devices each for capturing periodic performance data relating to at least one key performance criteria predetermined by management for at least one of said plurality of workers during a tabulation period.

4. The productivity system of claim 1 wherein at least one of the key performance criteria comprises a count of dispositions, a physical measures, a numerical indicator of a subjective assessment.

5. The productivity system of claim 1 further comprising a performance criteria algorithm for converting raw input data in numerical measures of key performance criteria for purposes of comparing diverse job assignments.

6. The productivity system of claim 5 wherein the performance criteria algorithm comprises at least one of converting any negative raw data value to zero, computing a moving average of multiple raw data measures, setting the performance criteria at a maximum or minimum of the raw data, converting the raw data to a number on a defined scale, or combining multiple types of raw data to derive a single performance criteria value.

7. The productivity system of claim 1 wherein said productivity algorithm comprises multiplying each performance criteria by its respective assigned weight and then summing the products to determine the composite numerical score.

8. The productivity system of claim 1 wherein said reward is a bonus paid to at least some employees based upon a applying a bonus algorithm to said composite numerical scores.

9. The productivity system of claim 1 wherein a subgroup of employees are selected based upon the composite numerical scores to participate in a prorated distribution of a preset bonus pool.

10. The productivity system of claim 1 wherein the reward period coincides with the employees' pay period.

11. The productivity system of claim 1 wherein employees and stakeholders in the performance of employees receive at least one of a report, notification, or display of information harvested or computed by the productivity system.

12. The productivity system of claim 1 wherein at least two different composite numerical scores are computed for different purposes.

13. The productivity system of claim 1 wherein the organization is at least one of a for profit company, a non-profit company, a government, an informal team, or a portion of a for profit company, a non-profit company, or a government.

14. The productivity system of claim 1 wherein at least one measurements of employee performance is compared with a benchmark to determine a numerical value for a performance criteria and wherein the benchmark is periodically revised to reflect recent performance to encourage continuous process improvement.

15. The productivity system of claim 1 wherein performance criteria are assigned to specific tasks and each employee's composite numerical score is at least partially determined by the performance of the employee against the performance criteria assigned to the tasks in which the employee is engaged.

16. The productivity system of claim 15 wherein the weight assigned to at least one performance criteria for an employee is at least partially determined by the portion of the employee's time spent engaging in the task associated with the performance criteria.

17. The productivity system of claim 1 wherein at least one performance criteria is tied to performance in connection with completion of a work order.

18. The productivity system of claim 1 wherein at least one performance criteria for at least one team of employees is tied to the performance of the team.

19. The productivity system of claim 1 wherein performance of criteria of both employees and equipment are determined and actions related to equipment are initiated in response to the performance of equipment.

20. A productivity method for evaluating a plurality of workers in an organization comprising:
for capturing periodic performance data, using an input capture device, relating to each of a plurality of key performance criteria predetermined by management for each of said plurality of workers during a tabulation period;
storing periodic performance data, weights assigned by management to each of said key performance criteria and a productivity algorithm for processing said key performance criteria and said weights in a data storage device;
performing said productivity algorithm on a computing device to process said periodic performance data and said weights to determine a periodic composite numerical score for each of said plurality of workers, said periodic composite numerical score being reflective of management's appraisal of the relative value said worker added to said organization during said tabulation period; and
processing said periodic numerical score on a computing device using a formula preset by management of said organization to calculate and assign a reward for any of said workers performing at a level deemed worthy of said rewards by management of said organization.
